(19) United States
(12) Patent Application Publication
(10) Pub. No.: US 2016/0161624 A1
(43) Pub. Date: Jun. 9, 2016

(54) METHOD AND APPARATUS FOR THE DETECTION AND IDENTIFICATION OF BURIED OBJECTS USING IMPEDANCE SPECTROSCOPY AND IMPEDANCE TOMOGRAPHY

(71) Applicant: TransTech Systems, Inc., Schenectady, NY (US)

(72) Inventors: Sarah E. Pluta, Scotia, NY (US); Donald D. Colosimo, Saratoga Springs, NY (US); John W. Hewitt, Niskayuna, NY (US)

(73) Assignee: TransTech Systems, Inc., Schenectady, NY (US)

(21) Appl. No.: 14/027,520

(22) Filed: Sep. 16, 2013

Related U.S. Application Data
(60) Provisional application No. 61/703,488, filed on Sep. 20, 2012.

(51) Int. Cl. G01V 3/12; G01V 3/38

(52) U.S. Cl. CPC G01V 3/12; G01V 3/38

(57) ABSTRACT

Methods include: providing instructions to a signal generator to transmit a first set of tomographic signals to a surface and a subsurface beneath the surface; obtaining a first return signal about the surface and the subsurface beneath the surface, the first return signal associated with the first set of tomographic signals; comparing the first return signal with the first set of tomographic signals to determine whether an object is present within the subsurface; providing instructions to the signal generator to transmit a set of spectrographic signals to the surface and subsurface in response to determining the object is present within the subsurface; obtaining a second return signal about the surface and subsurface beneath the surface, the second return signal associated with the set of spectrographic signals; and comparing the second return signal with the set of spectrographic signals to determine a characteristic of the object within the subsurface.

### CROSS-REFERENCE TO RELATED APPLICATION

This application claims the benefit of U.S. Provisional Application Ser. No. 61/703,488, filed on Sep. 20, 2012, which is incorporated by reference herein in its entirety.

### TECHNICAL FIELD

The invention relates generally to the detection and characterization of buried objects such as utilities, archeological objects, and hazards. Various embodiments are applicable to the detection of Buried Explosive Hazards (BEH), such as leaking gas lines, land mines and Improvised Explosive Devices (IED). More particularly, various embodiments of the invention relate to detecting (and in some cases characterizing) buried objects with greater accuracy, speed and detection depth than current approaches.

### BACKGROUND

Detecting buried objects, such as those buried as a result of human activities, can be beneficial for a number of reasons. These buried objects can include various utilities, archeological objects, hazards, etc. A significant concern is the detection of weapon-like buried objects such as Buried Explosive Hazards (BEH). Despite previous efforts to improve the detection of BEHs, there are generally two accepted modalities used for detection of buried objects: ground penetrating radar (GPR); and electromagnetic induction (EMI). Both approaches have limitations on their effectiveness, notably, high rates of false alarms.

### SUMMARY

Aspects of the invention include systems and methods for performing scanning, detection and characterization of buried objects with a person portable or vehicle mounted system.

Various embodiments include a system having: an array of electrodes for non-conductively communicating with soil, ground or road surface; a signal generator operably connected with the array of electrodes, the signal generator for transmitting oscillating electromagnetic field signals through the array of electrodes at a range of selected frequencies; and at least one computing device operably connected with the signal generator and the array of electrodes, the at least one computing device configured to: obtain a return signal from the array of electrodes about the soil; compare the return signal with the oscillating electromagnetic field signals to determine a difference in an aspect of the return signal and the aspect of the oscillating electromagnetic field signals; compare the difference in the aspect to a predetermined threshold; and determine the presence of a potential buried object, the location, and even characterize it.

Various other embodiments include a signal generator for transmitting oscillating electromagnetic field signals through the array of electrodes at a range of frequencies; and at least one computing device operably connected with the signal generator and the array of electrodes, the at least one computing device configured to: obtain a return signal from the array of electrodes about the buried object; compare the return signal with the oscillating electromagnetic field signals to determine a difference in an aspect of the return signal and the aspect of the oscillating electromagnetic field signals; compare the difference in the aspect to a predetermined threshold; and determine a characteristic of the buried object based upon the compared difference.

Various other embodiments include a computer program having program code stored on a computer-readable medium, which when executed by at least one computing device, causes the at least one computing device to: provide instructions for transmitting oscillating electromagnetic field signals to the soil and the BEH target; obtain a return signal associated with the transmitted oscillating electromagnetic field signals; compare the return signal with the oscillating electromagnetic field signals to determine a difference in an aspect of the return signal and the aspect of the oscillating electromagnetic field signals; compare the difference in the aspect to a predetermined threshold; detect and locate a potential BEH target; and determine a characteristic of the BEH target based upon the compared difference.

Various additional embodiments include a computer-implemented method including: providing instructions (e.g., to a signal generator/transmitter) for transmitting oscillating electromagnetic field signals to the soil and BEH target; obtaining a return signal associated with the transmitted oscillating electromagnetic field signals; comparing the return signal with the oscillating electromagnetic field signals to determine a difference in an aspect of the return signal and the aspect of the oscillating electromagnetic field signals; comparing the difference in the aspect to a predetermined threshold; detecting and locating a potential BEH target; and determining a characteristic of the BEH target based upon the compared difference.

Additional embodiments include: a means for displaying the results of the scanning and characterization; an integration between the scanning results and the vehicle for automatic control of the vehicle motion; and auditory alarm signal.

Various additional embodiments include a system having: an array of electrodes for non-conductively communicating with a surface and a subsurface beneath the surface; a signal generator operably connected with the array of electrodes; and at least one computing device

operably connected with the signal generator and the array of electrodes, the at least one computing device configured to: instruct the signal generator to transmit a first set of tomographic signals to the array of electrodes; obtain a first return signal from the array of electrodes about the surface and the subsurface beneath the surface; compare the first return signal with the first set of tomographic signals to determine whether an object is present within the subsurface; instruct the signal generator to transmit a set of spectrographic signals from the array of electrodes in response to determining the object is present within the subsurface; obtain a second return signal from the array of electrodes about the surface and the subsurface beneath the surface; and compare the second return signal with the set of spectrographic signals to determine a characteristic of the object within the subsurface.

Various other embodiments include a computer-implemented method including: providing instructions to a signal generator to transmit a first set of tomographic signals to a surface and a subsurface beneath the surface; obtaining a first return signal about the surface and the subsurface beneath the surface, the first return signal associated with the first set of tomographic signals; comparing the first return signal with the first set of tomographic signals to determine whether an object is present within the subsurface; providing instructions to the signal generator to transmit a set of spectrographic signals to the surface and the subsurface in response to determining the object is present within the subsurface; obtaining a second return signal about the surface and the subsurface beneath the surface, the second return signal associated with the set of spectrographic signals; and comparing the second return signal with the set of spectrographic signals to determine a characteristic of the object within the subsurface.

Various additional embodiments include a computer program comprising program code stored on a computer-readable medium, which when executed by at least one computing device,

causes the at least one computing device to: provide instructions to a signal generator to transmit a first set of tomographic signals to a surface and a subsurface beneath the surface; obtain a first return signal about the surface and the subsurface beneath the surface, the first return signal associated with the first set of tomographic signals; compare the first return signal with the first set of tomographic signals to determine whether an object is present within the subsurface; provide instructions to the signal generator to transmit a set of spectrographic signals to the surface and the subsurface in response to determining the object is present within the subsurface; obtain a second return signal about the surface and the subsurface beneath the surface, the second return signal associated with the set of spectrographic signals; and compare the second return signal with the set of spectrographic signals to determine a characteristic of the object within the subsurface.

Various other embodiments include a computer-implemented method including: initiating a tomography analysis of a surface and a subsurface beneath the surface to detect an object within the subsurface; and initiating a spectrographic analysis of the subsurface in response to detecting the object within the subsurface, the spectrographic analysis for determining a characteristic of the buried object.

Various additional embodiments include a system having: an array of electrodes for non-conductively communicating with a surface and a subsurface beneath the surface; a signal generator operably connected with the array of electrodes; at least one computing device operably connected with the signal generator and the array of electrodes, the at least one computing device configured to perform sequential tomographic and spectrographic surveys of the surface and the subsurface.

### BRIEF DESCRIPTION OF THE DRAWINGS

FIG. 1 is an illustration of the dielectric spectrum of an idealized material according to the prior art;

FIG. 2 is an illustration of the dielectric spectrum of a real material, soil, according to prior art.

FIG. 3 is an illustration of the logic flow of one aspect of the application of the invention;

FIG. 4 is a diagram of a test sensor array used to verify the concept of the invention;

FIG. 5 is a photograph of a test fixture simulating object (e.g., BEH) targets;

FIG. 6 is listing of the simulated object (e.g., BEH) targets and there location in the test fixture;

FIG. 7 shows the raw values of conductance and susceptance at a single frequency from the test with the object (BEH) simulants of FIG. 6;

FIG. 8 shows a sample analysis of a complex impedance signal illustrating the effect of the simulated object (BEH) targets of FIG. 7;

FIG. 9 shows a schematic depiction of a circuit system used according to various embodiments of the invention;

FIG. 10 shows a schematic depiction of a linear sensor array according to various embodiments of the invention;

FIG. 11 show a Comsol-Multiphysics finite element model of the sensor array in FIG. 10;

FIG. 12 illustrates a sensor array that can be used with a portable (e.g., handheld) system according to various embodiments of the invention;

FIG. 13 illustrates a sensor array that can be used with a vehicle mounted system according to various embodiments of the invention;

FIG. 14 is a table illustrating relationships between vehicle speed, object (BEH) size and the electronic sampling rate;

FIG. 15 illustrates a schematic depiction of a sensor array and a depth of penetration into a surface/subsurface according to various embodiments of the invention;

FIG. 16 illustrates the volumes (or “voxels”) measured by the sensor array of FIG. 15.

FIG. 17 illustrates a schematic graphical depiction of the position of a vehicle relative to a ground surface plotted in conjunction with conductance;

FIG. 18 is a flow diagram depicting a method according to various embodiments of the invention;

FIG. 19 is a flow diagram depicting a sub-method associated with the flow of FIG. 18;

FIG. 20 is a flow diagram depicting an additional sub-method associated with the flow of FIG. 18;

FIG. 21 is a flow diagram depicting another sub-method associated with the flow of FIG. 18;

FIG. 22 depicts an illustrative environment including an object/detection identification system according to various embodiments of the invention; and

FIG. 23 depicts a vehicle and a sensor system within an environment according to various embodiments of the invention.

### DETAILED DESCRIPTION

As noted herein, various aspects of the invention include systems and methods for performing the detection and characterization of Buried Explosive Hazards (BEH).

While some aspects of the disclosure focus on the detection and characterization of BEH targets, it will be obvious to one skilled in the art to direct the application to the detection and characterization of any other buried object.

Various embodiments of the invention include an instrument (in some cases, a centralized instrument) utilizing Electromagnetic Impedance Spectroscopy (EIS) and Electromagnetic Impedance Tomography (EIT) to improve the accuracy of detection of buried objects compared with conventional approaches. These various embodiments allow for more accurate characterization of a subsurface object (e.g., a BEH), and offer the potential to increase the probability of detecting these hazards at a higher speed and greater depth, with faster resolution and reduction in false positives.

Various embodiments include a system having: an array of electrodes for non-conductively communicating with a surface (e.g., soil, ground, or road surface): a signal generator operably connected with the array of electrodes, the signal generator for transmitting oscillating electromagnetic field signals through the array of electrodes at a range of selected frequencies; and at least one computing device operably connected with the signal generator and the array of electrodes, the at least one computing device configured to: obtain a return signal from the array of electrodes about the soil; compare the return signal with the oscillating

electromagnetic field signals to determine a difference in an aspect of the return signal and the aspect of the oscillating electromagnetic field signals; compare the difference in the aspect to a predetermined threshold; and determine the presence of a subsurface object (and in some cases, the location of the subsurface object) based upon the compared difference.

It is understood that in some embodiments, the array of electrodes is located a distance from the surface during transmission and reception of signals to and from the surface. It is further understood that in some embodiments the array of electrodes uneven with respect to the surface, e.g., because of movement of the array of electrodes. Further, in some cases, the array of electrodes transmits signals and/or receives signals while moving transversely and/or perpendicularly with respect to the surface.

Various other embodiments include a computer program having program code stored on a computer-readable medium, which when executed by at least one computing device, causes the at least one computing device to: provide instructions for transmitting oscillating electromagnetic field signals to the soil and the BEH target; obtain a return signal associated with the transmitted oscillating electromagnetic field signals; compare the return signal with the oscillating electromagnetic field signals to determine a difference in an aspect of the return signal and the aspect of the oscillating electromagnetic field signals; compare the difference in the aspect to a predetermined threshold; detect and locate a potential BEH target; and determine a characteristic of the BEH target based upon the compared difference. Various additional embodiments include a computer-implemented method including: providing instructions for transmitting oscillating electromagnetic field signals to a ground and targets (e.g., a material under test, or, MUT); obtaining a return signal associated with the transmitted oscillating electromagnetic field signals; comparing the return signal with the oscillating electromagnetic field signals to determine a difference in an aspect of the return signal and the aspect of the oscillating electromagnetic field signals; comparing the difference in the aspect to a predetermined threshold; and determining a characteristic of the ground based return signal upon the compared difference.

Various additional embodiments include a computer-implemented method including: providing instructions (e.g., to a signal generator/transmitter) for transmitting oscillating electromagnetic field signals to the soil and BEH target; obtaining a return signal associated with the transmitted oscillating electromagnetic field signals; comparing the return signal with the oscillating electromagnetic field signals to determine a difference in an aspect of the return signal and the aspect of the oscillating electromagnetic field signals; comparing the difference in the aspect to a predetermined threshold; detecting and locating a potential BEH target; and determining a characteristic of the BEH target based upon the compared difference.

Additional embodiments include: a means for displaying the results of the scanning and characterization; an integration between the scanning results and the vehicle for automatic control of the vehicle motion; and auditory alarm signal.

Various additional embodiments include a system having: an array of electrodes for non-conductively communicating with a surface and a subsurface beneath the surface; a signal generator operably connected with the array of electrodes; and at least one computing device operably connected with the signal generator and the array of electrodes, the at least one computing device configured to: instruct the signal generator to transmit a first set of tomographic signals from the array of electrodes; obtain a first return signal from the array of electrodes about the surface and the subsurface beneath the surface; compare the first return signal with the first set of tomographic signals to determine whether an object is present within the subsurface; instruct the signal generator to transmit a set of spectrographic signals from the array of electrodes in response to determining the object is present within the subsurface; obtain a second return signal from the array of electrodes about the surface and the subsurface beneath the surface; and compare the second return signal with the set of spectrographic signals to determine a characteristic of the object within the subsurface.

Various other embodiments include a computer-implemented method including: providing instructions to a signal generator to transmit a first set of tomographic signals to a surface and a subsurface beneath the surface; obtaining a first return signal about the surface and the subsurface beneath the surface, the first return signal associated with the first set of tomographic signals; comparing the first return signal with the first set of tomographic signals to determine whether an object is present within the subsurface; providing instructions to the signal generator to transmit a set of spectrographic signals to the surface and the subsurface in response to determining the object is present within the subsurface; obtaining a second return signal about the surface and the subsurface beneath the surface, the second return signal associated with the set of spectrographic signals; and comparing the second return signal with the set of spectrographic signals to determine a characteristic of the object within the subsurface.

Various additional embodiments include a computer program comprising program code stored on a computer-readable medium, which when executed by at least one computing device, causes the at least one computing device to: provide instructions to a signal generator to transmit a first set of tomographic signals to a surface and a subsurface beneath the surface; obtain a first return signal about the surface and the subsurface beneath the surface, the first return signal associated with the first set of tomographic signals; compare the first return signal with the first set of tomographic signals to determine whether an object is present within the subsurface; provide instructions to the signal generator to transmit a set of spectrographic signals to the surface and the subsurface in response to determining the object is present within the subsurface; obtain a second return signal about the surface and the subsurface beneath the surface, the second return signal associated with the set of spectrographic signals; and compare the second return signal with the set of spectrographic signals to determine a characteristic of the object within the subsurface.

Various other embodiments include a computer-implemented method including: initiating a tomography analysis of a surface and a subsurface beneath the surface to detect an object within the subsurface; and initiating a spectrographic analysis of the subsurface in response to detecting the object within the subsurface, the spectrographic analysis for determining a characteristic of the buried object.

Additional embodiments can include a system having: an array of electrodes for non-conductively communicating with a surface and a subsurface beneath the surface; a signal generator operably connected with the array of electrodes; at least one computing device operably connected with the signal generator and the array of electrodes, the at least one computing device configured to perform sequential tomographic and spectrographic surveys of the surface and the subsurface.

As described herein, the objective of non-conductively detecting and locating an object (e.g., a potential BEH target) can be achieved with electromagnetic impedance tomography. The characterization of the BEH target can then be achieved with electromagnetic impedance spectroscopy. The application of impedance tomography and spectroscopy, successively can be achieved using a sensor array which is not in conductive electrical contact with the surface or subsurface (below the surface) of interest. In various embodiments, the surface and/or subsurface can include soil, ground or road surface (hereafter “ground” will be used to mean soil, ground, ground covered by vegetation or paved or unpaved road surface, which can include asphalt and/or asphalt emulsion). Various embodiments include applying successive sets of signals (e.g., tomographic, and subsequently, spectrographic) to the surface and subsurface to determine whether an object is contained within the subsurface, and in some cases, to characterized that object. More particularly, various embodiments include applying an electromagnetic field over a range of frequencies selected to enhance (and in some cases, optimize) the detection location and characterization of the object (e.g., a BEH target). The range of frequencies used may be different for the tomographic and the spectrographic applications.

The sensor array can be designed to provide readings to different depths into the combination of the surface and subsurface (e.g., ground). The measured complex impedance at selected frequencies can then be analyzed by various methods to detect and locate a potential object of interest (e.g., a BEH target). The sampling rate for the tomographic detection can be achieved at a rate which permits a vehicle on which the sensor array is mounted to travel at a higher speed than the conventional speeds of similar vehicles, e.g., less than 5 km/hr (3 miles/hr). For example, using the systems according to various embodiments of the invention, the time required to take a tomographic reading and determine the presence of an anomaly is in the range of 0.01 to 0.05 seconds, allowing for a vehicle on which the sensor array is mounted travel at speeds greater than approximately 5 miles/hr, and in particular cases, up to 7-10 miles/hr. After identification of an object within the subsurface, the object of interest can be analyzed by the sensor array by providing an electromagnetic impedance spectrogram over a range of selected frequencies (e.g., frequencies distinct from those utilized in the tomographic detection of the object). The measured complex impedance spectrogram is then used to characterize the object of interest to determine a characteristic of the target (e.g., a size, shape, density, etc.), which may indicate that the object includes a BEH (and which type of BEH). The spectrographic analysis requires a longer time than the tomographic detection, e.g., approximately 20 to 40 seconds.

In achieving these objectives, the shortcomings of conventional methodologies are overcome. Specifically, the conventional methodologies are limited in the speed with which a vehicle can travel while utilizing the systems described herein. Further, conventional approaches are limited in their depth of detection; provide inadequate resolution; and incur high rates of false positive identification.

Impedance Spectroscopy Description:

Impedance spectroscopy has been used for the evaluation of material characteristics. In general, the macroscopic interaction of electromagnetic fields with materials is described by Maxwell's equations. Solution of Maxwell's equations involves knowledge of three constitutive properties of the material: the magnetic permeability, the dielectric permittivity, and the electrical conductivity. In general, these parameters are dependent upon material composition and physical properties, temperature, and frequency of the applied field.

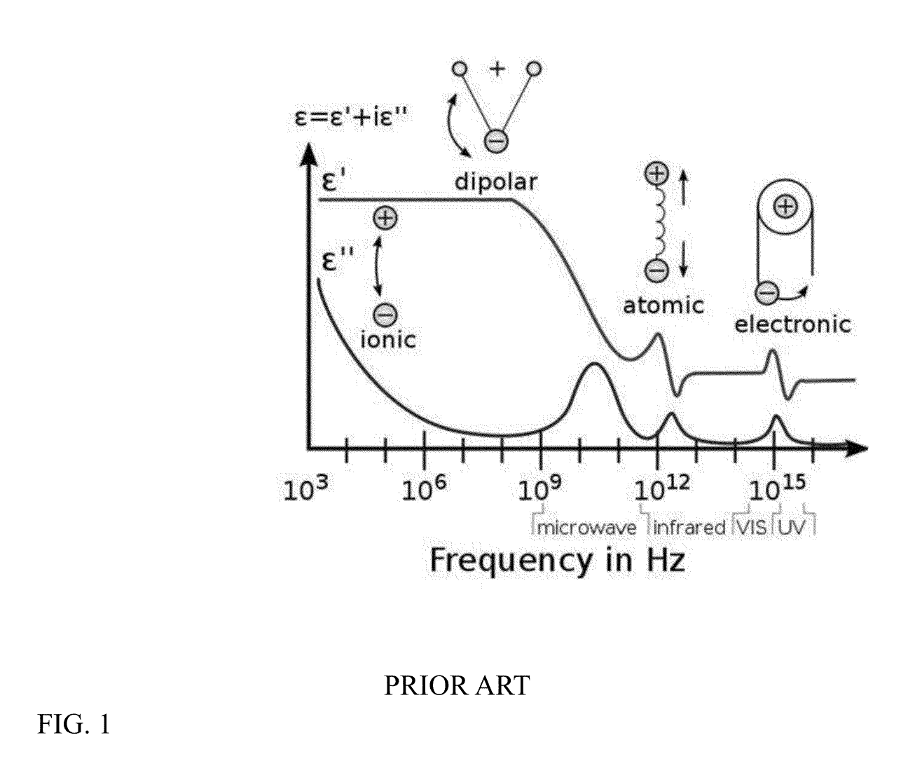

As opposed to the response of a vacuum, the response of materials to external fields generally depends on the frequency of the field. This is demonstrated in the example frequency graph of FIG. 1, according to the prior art. This frequency spectroscopy is due to the fact that a material's polarization does not respond instantaneously to an applied field. The response is causal (arising after the applied field) which can be represented by a phase difference. For this reason, permittivity is often treated as a complex function (since complex numbers allow specification of magnitude and phase) of the (angular) frequency of the applied Field ω, ∈→\hat{∈}(ω). The characterization of permittivity therefore becomes:

D₀e^{-iωt}=\hat{∈}(ω)E₀e^{-iωt}. (Equation 1)

where D₀ and E₀ are the amplitudes of the displacement and electrical fields, respectively, i is the imaginary unit, i²=−1.

The response of a medium to static electric fields can also be described by the low-frequency limit of permittivity, also called the static permittivity ∈ₛ (also _{∈DC}):

$${ɛ}_{s} = {lim}_{ω \to 0} \hat{ɛ} ( ω ) . \qquad ( Equation 2 )$$

At the high-frequency limit, the complex permittivity is commonly referred to as ∈_{∞}. The static permittivity can form a good approximation for alternating fields of low frequencies, and as the frequency increases a measurable phase difference δ emerges between D and E. The frequency at which the phase shift becomes noticeable depends on temperature and the details of the medium. For moderate field strength (E₀), D and E remain proportional, and:

$$\hat{ɛ} = \frac{{D}_{0}}{{E}_{0}} = \vert ɛ \vert {e}^{i δ} . \qquad ( Equation 3 )$$

Since the response of materials to alternating fields is characterized by a complex permittivity, it is natural to separate its real and imaginary parts, which is done by convention in the following way:

$$\hat{ɛ} ( ω ) = {ɛ}^{′} ( ω ) + i {ɛ}^{″} ( ω ) = \frac{{D}_{0}}{{E}_{0}} ( cos δ + i sin δ ) . \qquad ( Equation 4 )$$

Where: ∈″ is the imaginary part of the permittivity, which is related to the dissipation (or loss) of energy within the medium; and, ∈′ is the real part of the permittivity, which is related to the stored energy within the medium.

It may be helpful to realize that the choice of sign for time-dependence, exp (−iωt), dictates the sign convention for the imaginary part of permittivity. The signs used here correspond to those commonly used in physics, whereas for the engineering convention one should reverse all imaginary quantities.

The complex permittivity is usually a complicated function of frequency co, since it is a superimposed description of dispersion phenomena occurring at multiple frequencies. The dielectric function ∈(ω) has poles only for frequencies with positive imaginary parts. However, in the narrow frequency ranges sometimes observed, the permittivity can be approximated as frequency-independent or by model functions.

In the following description, application of electromagnetic fields to soils and concrete are discussed to illustrate the effects of making measurements in real materials. Soils share a characteristic with concrete and the other materials to which this technology can be applied in that they all contain water. The determination of a material characteristic where the material contains water can be challenging. Typically, for the materials of interest described herein, as well as many soils, the permeability is nearly that of free space and the conductivity is low (2-6 mS/cm). As a result, the electromagnetic response of soil can be determined by its dielectric properties. Soil can be a porous medium consisting of a heterogeneous mixture of pore fluids, air and soil particles of different mineralogy, size, shape and orientation.

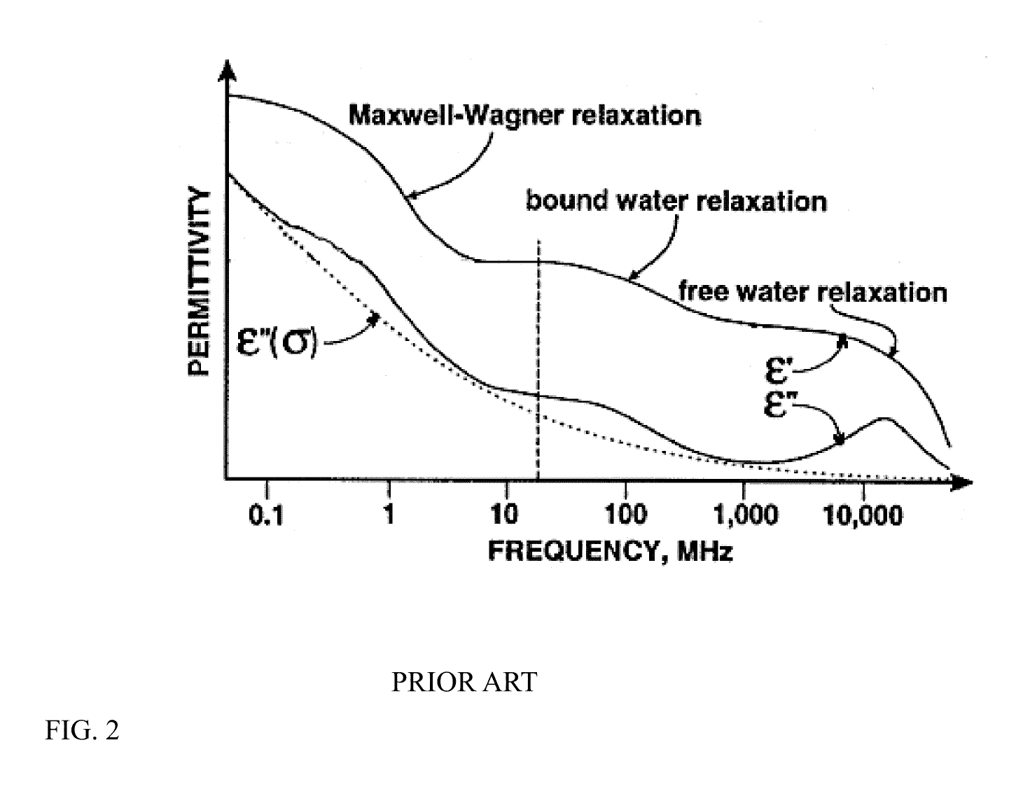

The heterogeneity of soil combined with significant interfacial effects between the highly polar water molecules and the soil's solid surface results in a complex electrical response for which good conventional phenomenological theories do not exist. There are three primary polarization effects in soil: bound water polarization, double layer polarization, and the Maxwell-Wagner (M-W) effect (illustrated in the prior art frequency-permittivity graph in FIG. 2). The bound water polarization results from the fact that water can be electro-statically bound to the soil matrix. The degree of binding varies from unbound or free water at a great distance (>10 molecular diameters) from the matrix surface, to heavily bound, or adsorbed, water.

If water becomes bound to the soil matrix, the water may not be capable of doing as much work, and hence has lost energy. The relaxation frequency and the apparent dielectric constant of bound water are less than that of free water. Double layer polarization is due to separation of cations and anions in an electric double layer around clay particles. This double-layer polarization is a surface phenomenon that is dominant at frequencies <100 kHz. Double layer polarization is mostly observed in soils containing a large fraction of clay. The M-W effect is one phenomenon which affects the low radio frequency dielectric spectrum of soils. The M-W effect is a macroscopic phenomenon that depends on the differences in dielectric properties of the soil constituents. It is a result of the distribution of conducting and non-conducting areas in the soil matrix. This interfacial effect is significant at frequencies between 100 kHz and 500 MHz, below the frequencies where bound and free water relaxations play a dominant role. Above this frequency range, the dielectric response can be empirically described by mixing equations in which the matrix bulk dielectric constant is proportional to the sum of the products of the volume fractions and dielectric constants of the constituents. At frequencies below the M-W relaxation, the apparent permittivity may increase more than an order of magnitude from its value in the mixing region. The conductivity is also dispersive, falling with frequency, as shown in FIG. 2. The dielectric spectrum can be roughly divided into two parts. The higher frequencies can be dominated by the bound and free water relaxations and the lower frequencies can be dominated by the M-W effect.

The dielectric characteristics of soils may be considered generally as a mixture of three components: air, stone, and water, with water acting to help bind the stone matrix together. Some research has shown that the matrix bulk dielectric constant may be derived from the volume fractions and dielectric constants of the constituents according to the following, empirically derived, soil dielectric mixing equation:

k=[θk_{w}^{α}+(1−η)kₛ^{α}+(η−θ)kₐ^{α}]^{1/α} (Equation 5)

Here, k is the bulk dielectric constant; k_{w}, kₛ, kₐ are the respective dielectric constants of water, stone, and air; θ is the volume fraction of water; η is the porosity (so that 1−η is the volume fraction of stone, and η−θ is the volume fraction of air); and α is an empirically determined constant, different for each soil matrix. For sandy type soil matrices, α=0.46 has been found to be typical. Typical values for the component permittivity are: kₛ=3−5, k_{w}=80, and kₐ=1. As compaction increases, porosity decreases; the kₛ term drives k upward, while the kₐ term drives k downward, but because kₛ>kₐ, the net effect is an increase in k (regardless of the value of α, and even if α<0). The mathematics confirms: when removing the component with the lowest dielectric constant, the bulk dielectric constant should increase. The changes due to the reduction of the air in the mix and the relaxation characteristics of water can be used in impedance spectroscopy to determine the density and moisture content of the soil.

An object of interest (e.g., a BEH), as described according to various embodiments of the invention, will have a different dielectric characteristic than soils. This distinction is the basis for the discrimination between naturally occurring materials and an artificial body such as a BEH. For at least one characteristic, a BEH will not have a constituency of water and, in some cases, may have metallic or magnetic components which would provide further distinction from soil.

Additionally, disturbed soils or asphalts have a different impedance spectrum than undisturbed soils and asphalts. This change in spectrum may also be used in the identification of potential objects of interest (e.g., BEH target sites) according to various embodiments of the invention.

Impedance Tomography Description:

Impedance tomography has been used in prior research and development programs. Some of the techniques have been and are being applied to other tomographic modalities, such as Magnetic Resonance Imagining (MRI), Computed Assisted Tomography (CAT), and others. An exemplary list of some different approaches that can be used to develop an “image” from tomographic signals is included herein. While these approaches can provide an adequate 2-D or 3-D image, they may require extensive data and/or extensive computation. Approaches followed according to various examples herein, as discussed further below, can be based on a layered method.

Electromagnetic Inverse Methods:

Electromagnetic inverse-type methods begin by discretizing the region of interest into a large collection of voxels over which complex permittivity is assumed constant.

Electrical Resistance Tomography:

Electrical resistance tomography is based on the injection of electrical current into the earth at one location and the measurement of the resulting voltage drop across a pair of electrodes located elsewhere. By varying the locations of the current source and measurement electrodes using multiple boreholes or surface measurements and exploiting the physics relating the input current, output voltages, and electrical properties of the earth, it is possible to process the data to develop an “image” of the electrical conductivity in the region bounded by a measurement apparatus.

Shape Based Methods:

Modeling of shapes in 2D and 3D scenes function by aggregating pixels (or “voxels”) in a scene into those that are “inside” and those that are “outside” a region of interest.

Layered Forward Model:

This approach handles the problem posed by the inhomogeneous structure of human tissue, with thin low admittivity skin layers covering the relatively high admittivity tissue inside, making the imaging problem difficult. In addition, the electrical properties of skin vary considerably over frequency. The layered forward model incorporates the presence of skin. One layered model has three layers, thin low admittivity top and bottom layers representing skin and a thicker high admittivity middle layer representing tissue.

Applicants' Example Approaches:

For the purpose of promoting an understanding of the principals of the invention, reference will now be made to the embodiments as illustrated in the drawings and specific language will be used to describe the same. It will nevertheless be understood that no limitation of the scope of the invention is thereby intended, such alterations and further modifications in the illustrated device and such further applications of the principal of the invention as illustrated therein being contemplated as would normally occur to one skilled in the art to which the invention relates.

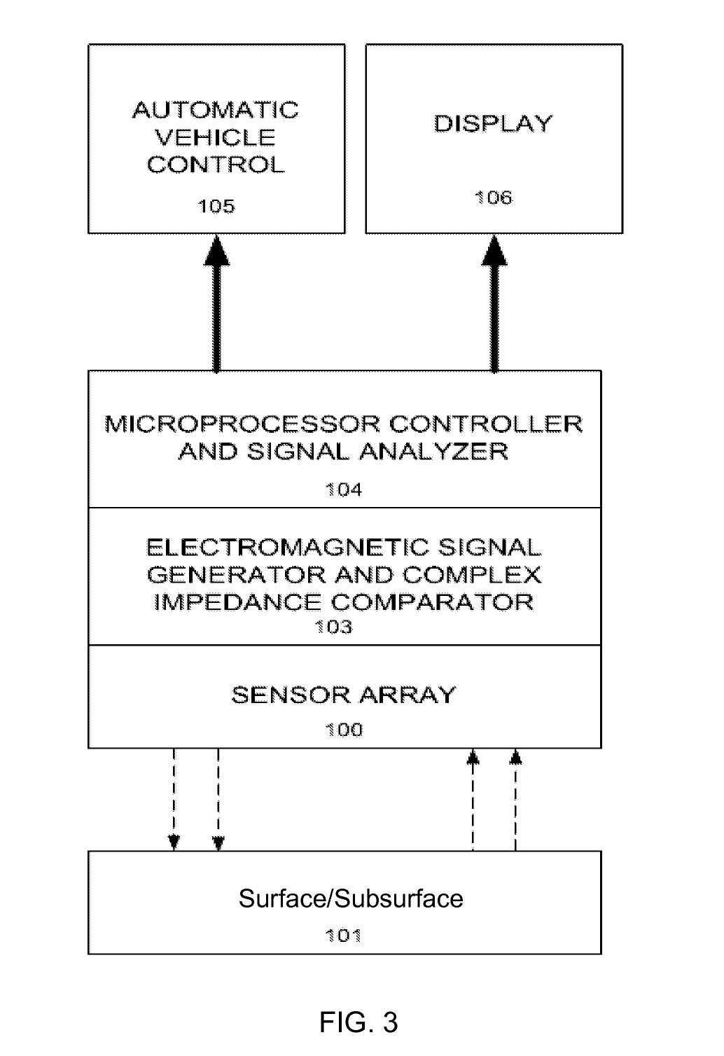

One approach to the system logic according to various embodiments is shown in FIG. 3. A sensor array (including a plurality of sensors), along with at least one computing device (further described herein), can be used to detect, and in some cases determine a characteristic of, an object of interest such as a buried explosive hazard. The sensor array is first operated as an impedance tomographic sensor to detect a potential target. Once a target is detected, the sensor array can be used as an impedance spectrographic sensor to characterize the detected target. If the target is characterized as an object of interest (e.g., a BEH), an operator (or other party) can be notified so that the target may be neutralized. The initial tomographic search can also locate the target in three dimensions.

Turning to the particular depiction in FIG. 3, the sensor array 100 can emit an electromagnetic field over a range of selected frequencies. The electromagnetic field can be generated by the electromagnetic signal generator and complex impedance comparator 103. The sensor array 100 can be non-conductively coupled to a surface/subsurface, e.g., a ground surface 101. The electromagnetic field can be affected by its interaction with the surface and the air gap between the sensor array and the surface. The returning electromagnetic field can be compared to the transmitted electromagnetic field in the electromagnetic signal generator and complex impedance analyzer 103. This comparison results a determination of the complex impedance of the surface and subsurface 101 by the measurement of the difference in the field strength (magnitude) and a phase shift (phase) between the transmitted field and the received field. These values along with the frequency of the field can be communicated to the microprocessor controller and signal analyzer 104. An algorithm can be used to determine whether a target (object of interest, e.g., a BEH) is detected, and, in response to detecting an object of interest, to characterize the object of interest. The microprocessor controller 104 also controls the electromagnetic signal generator 103 to specify the frequencies at which the search or characterization are conducted. The results from the microprocessor controller/analyzer 104 can then communicated to the automatic vehicle control (105) and/or the display (106) for the operator.

In making measurements and interpreting aspects of the complex impedance, it can be helpful to define terms that may be calculated from the output of the measurement device which are the magnitude of the power between the signal that is transmitted through the ground and the transmitted signal, m, and the phase angle, δ, shift between the transmitted signal and which occurs as the signal passes through the ground. Impedance (Z) is represented mathematically as a complex relation consisting of a real part, resistance, and an imaginary part, reactance:

Z=R+i X;

Z=the complex value of Impedance;

### R=m*cos δ; the Resistance;

### X=m*sin δ; the Reactance.

Resistance, R, is a material's opposition to the flow of electric current;
Reactance, X, is a material's opposition to alternating current due to capacitance (capacitive reactance) and/or inductance (inductive reactance);
Susceptance (B) is a complementary representation of the reactance in the term admittance and is defined mathematically as:

B=−X/(R²+X²);

The Susceptance may be computed from the measured impedance properties as follows:

### B=the Susceptance=−sin δ/m;

Admittance (Y) is a complex quantity which is the inverse of Impedance, and results in the definition of the terms of Conductance and Susceptance:

Y=1/Z=G+i B; Y=the Admittance;

The Conductance may be computed from the measured impedance properties as follows:

### G=the Conductance=cos δ/m.

The sensor array can interact with the ground and the target to obtain the complex impedance over a range of frequencies selected to enhance (e.g., maximize) the sensitivity to the properties of interest. In various embodiments, the range of frequencies can span between approximately 1 kilo-Hertz (kHz) and 50 mega-Hertz (MHz), however, other frequencies may be possible. The particular range of frequencies can be based upon material properties of the surface/subsurface and targets (e.g., the expected range of conductivity, permeability and permittivity of the ground and targets) and/or a desired depth of penetration into the surface and/or the subsurface beneath the surface. In a particular example, the range of frequencies applied to determine the wet density of a soil can range from 1 to 30 MHZ.

The resultant values of the complex impedance in terms of the magnitude change and the phase shift of the signal passing through the ground and targets relative to the input signal can be processed by the microprocessor (e.g., computing device). The computing device may apply an algorithm to the complex impedance data, where the algorithm can include a function of the susceptance or conductance over a range of frequencies, or an empirical correlation of the complex impedance to one or more physical properties of the ground and target. Again, the process can include two sub-processes: a tomographic search for an object of interest (or, target of interest); and a spectrographic characterization of the object.

Under vehicle-mounted operation, the computing device can communicate with a conventional vehicle controller (e.g., an automatic vehicle controller 105), e.g., to instruct that controller to modify a speed of the vehicle (e.g., stop the vehicle) upon the detection of a target of interest. In some cases, after the vehicle is stopped, the target of interest can be characterized. That is, the spectrographic analysis can be performed after slowing or stopping the vehicle. In various particular embodiments, the computing device can provide instructions to the vehicle controller to modify a speed of the vehicle (e.g., stop the vehicle) in response to detecting an object of interest (via the tomographic analysis). In some cases, the computing device can immediately instruct the vehicle controller to stop the vehicle in response to detecting an object of interest using the tomographic analysis. Stopping the vehicle in response to identifying an object of interest can provide a safety mechanism (by preventing the vehicle from closing in on the object of interest), and can also enhance the system's ability to characterize the object of interest (which is more effective from a static analysis). The computing device can subsequently initiate a spectrographic analysis process to characterize the object of interest in response to determining that the vehicle has reached its desired modified speed (e.g., zero kilometers per hour in the case of a stopped vehicle).

Under manual operation, the result is communicated to a display 106 where the operator may determine whether to continue to search or to switch to a characterization mode.

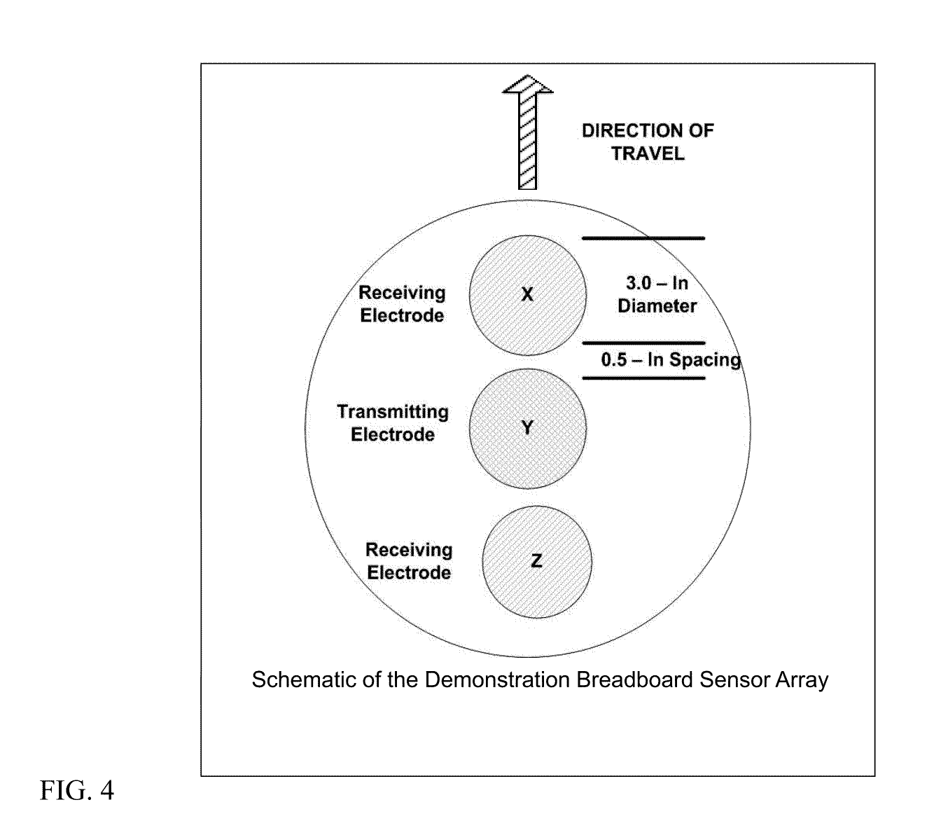

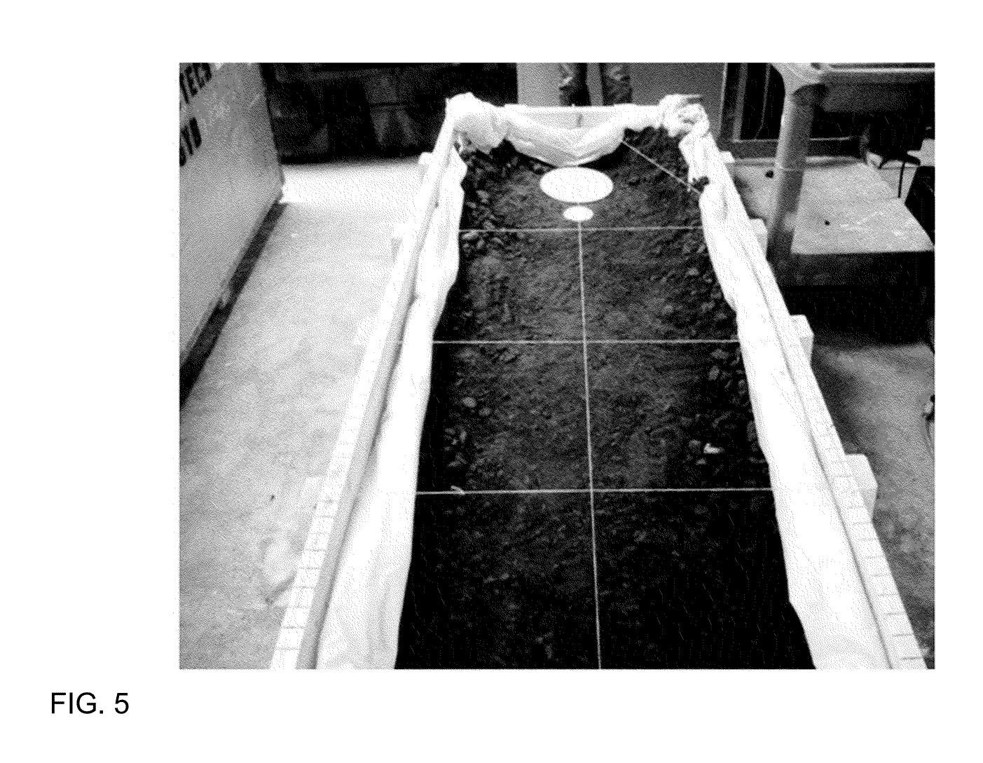

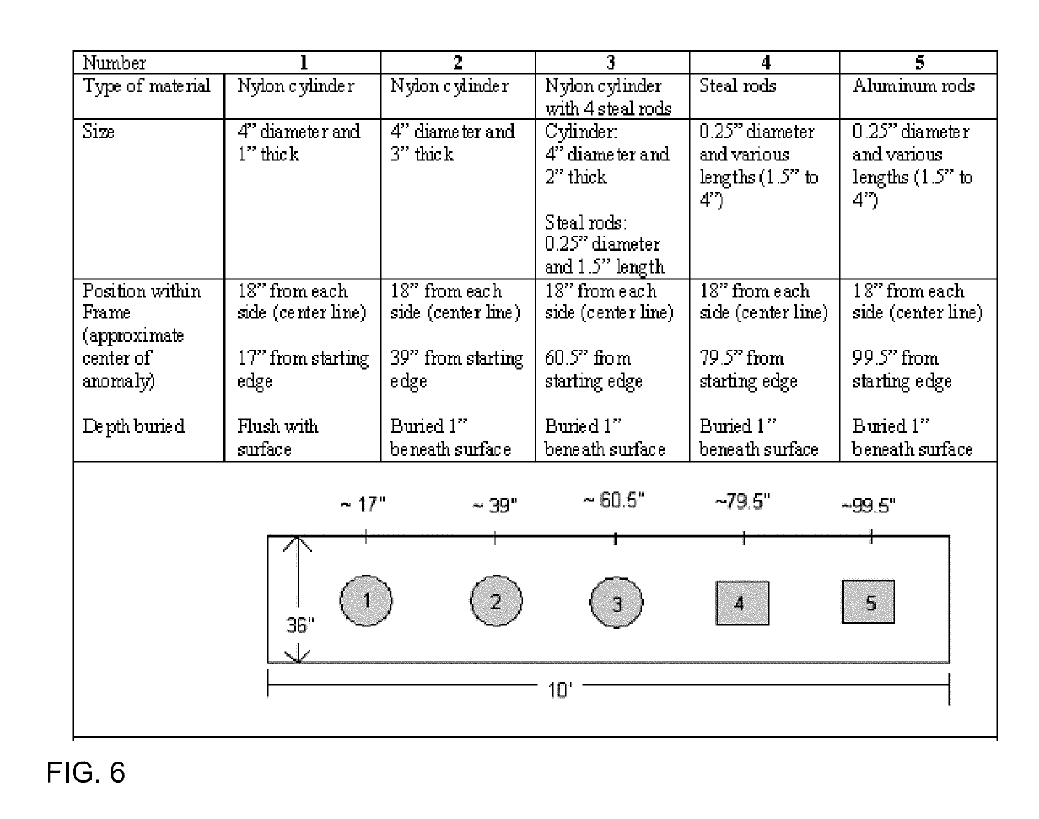

FIG. 4 shows a schematic depiction of an example test sensor array used according to various embodiments of the invention. This sensor was used in an example on a test in which various object (e.g., BEH) simulated targets were buried at various depths under a surface (e.g., in a soil). The test bed is illustrated in the photographic depiction shown in FIG. 5. Characteristics of the object simulants and their location data are provided in FIG. 6.

The objective of the example demonstration illustrated with respect to FIGS. 5-7 is to illustrate that electromagnetic impedance is able to detect an object (e.g., BEH) simulant within a subsurface, not necessarily to determine a depth or a characteristic of the object stimulant within the subsurface. In this example, a breadboard electrode array was constructed (as illustrated in FIG. 4). The array has three electrodes, e.g., of 7.5-cm (3-in) in diameter with 1.3-cm (0.5-in) spacing, i.e., the two electrodes had an 8.9-cm (3.5 in) center-to-center spacing. This array was used merely as an example to demonstrate principles of various embodiments of the invention. It is understood that the dimensions of this array are in no way limiting of the various aspects of the invention. As illustrated in FIG. 4, one electrode was designed to be a transmitting electrode (Y) and two electrodes were to be the receiving electrodes (X and Z). In this example test, only two electrodes were used, Y and Z; and a standoff of 0.64-cm (0.25-in) was used, i.e., there was a small air gap between the sensors and the surface. To complete the testing, an HP 4192A LF Impedance Analyzer was used, with HP16089D alligator clip leads, at a single frequency of 100 kHz. Electrodes Y and Z were the high and low impedance terminals from the impedance analyzer, respectively. The testing was completed within a wooden frame, approximately 0.9×3.1×4.5 meters (3×10×1.5 feet), using a common gravelly sand sub-base material (FIG. 5). Five objects simulants were buried within the soil in this example. FIG. 6 describes the object simulant characteristics and layout.

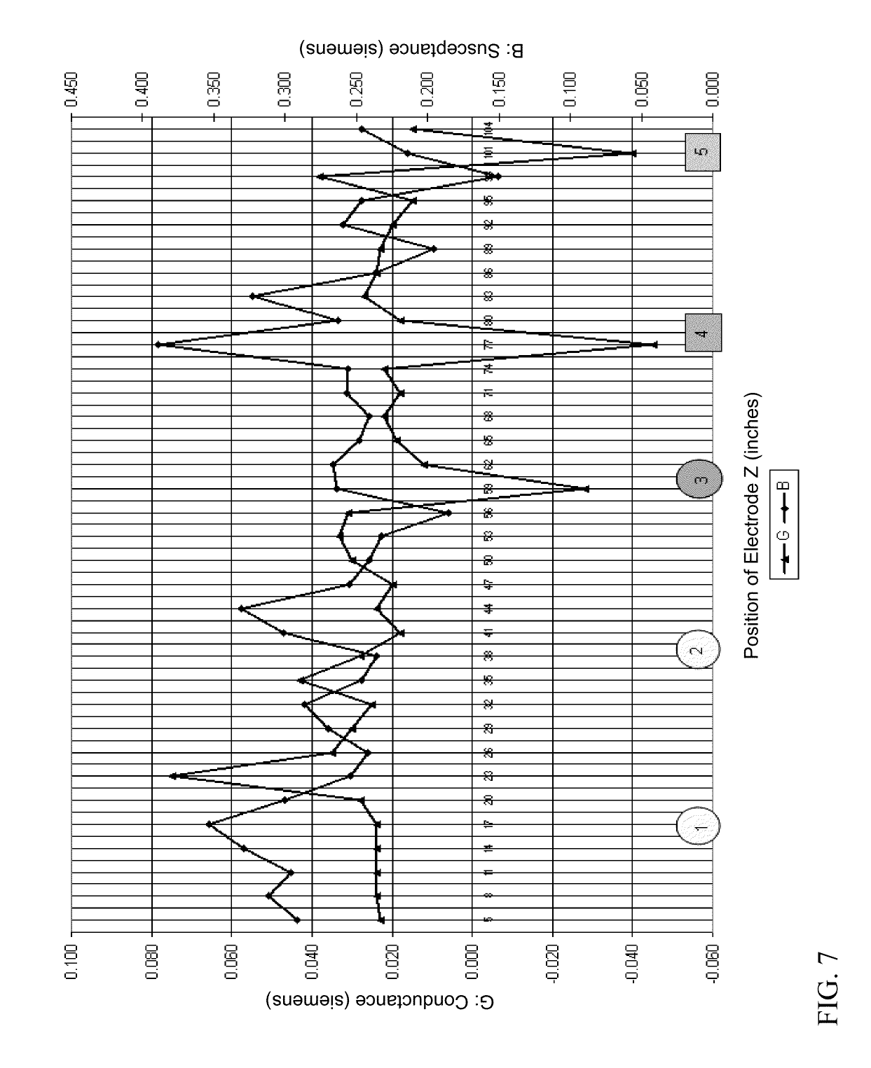

All the single frequency data were collected running down the center line of the box (FIG. 6) at 46-cm (18-in) from each side. The data is referenced using the center of electrode Z. The starting position of electrode Z was at 13-cm (5-in) (at box position: 46×13 cm (18×5 in), and the final data point was at reference point 264-cm (104-in) (at box position: 46×264 cm (18×104 in)). Data points were collected at 7.6-cm (3-in) intervals, i.e., for a total of 34 points. FIG. 7 shows the conductance and susceptance data collected with the electrode array and the HP Impedance Analyzer according to the examples noted herein.

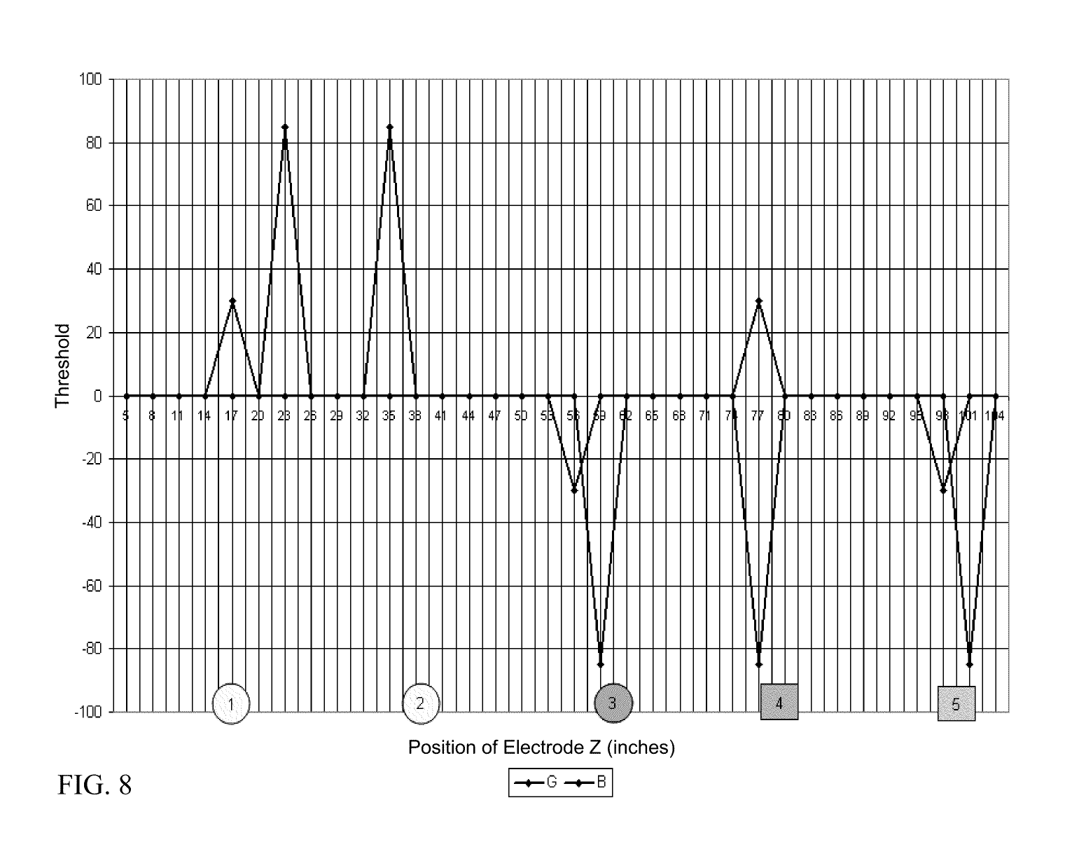

At the bottom of the plot in FIGS. 7 and 8, the approximate locations of the five anomalies (objects) are shown. The conductance is plotted as a solid line and the scale is on the primary y-axis. The susceptance is plotted as a dashed line and the scale is on the secondary y-axis. This plot includes a significant amount of noise. As soil can be a noisy medium due to normal soil conditions and the unevenness of the soil's surface, this noise can be expected. To determine whether the spikes were attributable to object detection or to noise, the average conductance and susceptance were calculated as 0.021 Siemens and 0.265 Siemens, respectively, and then each individual data point was compared to the average conductance or susceptance. A threshold for each was chosen such that if the individual point was greater than or less than the average by a certain percentage, it passed the threshold point. FIG. 8 shows the result of the threshold test, with conductance (solid line) and susceptance (dashed line) limits of 85% and 30%, respectively. At the bottom of the plot, there are approximate locations of the anomalies (objects) and the “zone of influence” of the anomalies may start before the sensors reach the anomalies and extend until after the sensors pass the anomalies. Using the threshold limits, the locations of the five anomalies became more apparent.

From FIGS. 7-8, it can be seen that the response of the conductance and susceptance of the nylon, steel and aluminum simulants are different. This is shown for only a single non-optimized frequency, which is able to detect and locate anomalies in one dimension. The use of electromagnetic impedance spectroscopy improves the ability to characterize and differentiate the anomalies. This improved characterization yields insight into the material properties of the anomaly (e.g., an object of interest), which will improve the probability of detection and reduce the number of false alarms.

This threshold processing technique, which is described herein for illustrative purposes only and not a limitation on the scope of the invention, shows one of many possible approaches to limit the “noise” and emphasize only the anomaly (e.g., object of interest). Other techniques may be used. Since this example testing was completed on a relatively homogenous material, i.e., no plant life on the surface, it was possible to average all the measurements for comparison to the individual measurements. However, in other environments, this averaging technique may not be as effective of an approach, as pockets of moisture, grass, rock, and other surface or subsurface irregularities may be measured. Therefore, advanced statistical methods may be employed. For example, a complex moving average model of localized electrodes could be tested. In some cases, using the complex moving average model, the nearest electrode measurements (e.g., of adjacent electrodes, or those within a particular threshold distance) can be compared, and subsequently, the number of compared electrodes can be expanded depending on the limits of the measured properties.

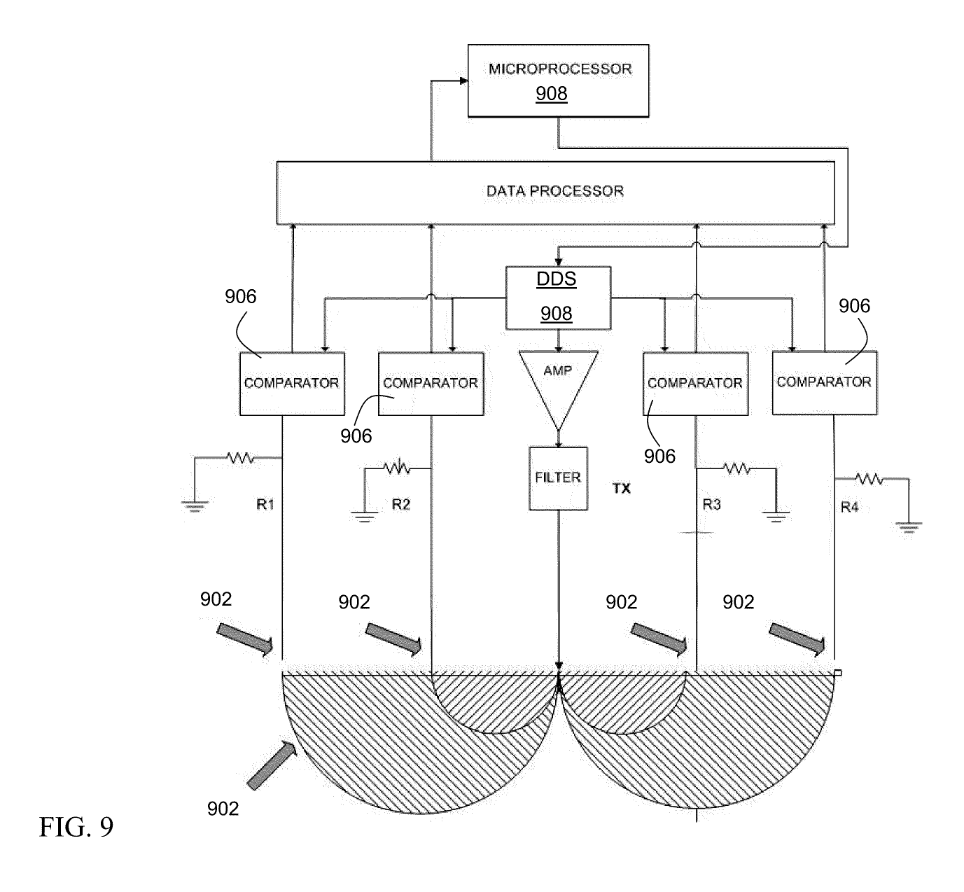

An additional schematic depiction of a system according to various embodiments of the invention is shown in FIG. 9. This schematic depiction shows a sensor system 900 with five electrodes 902, one of which 902A provides the input of the signal over a range of frequencies supplied by a signal generator 904, e.g., a DDS (Direct Digital Synthesizer). In this example, the other four electrodes can complete the circuit with the signal passing through the ground and targets. The original signal from the DDS can be compared to the signals passing through the ground and targets. The output of the comparator 906 is the difference in the magnitude of the signals and the phase shift. This magnitude and phase data can be transmitted to the microprocessor 908 which processes the data and transmits it to the statistical process control. The microprocessor can also control the DDS 904 to select the frequencies to be generated.

As noted herein, the electrodes 902 are configured to communicate with the ground and targets (potential objects of interest) but are not in electrical contact with the ground, that is, they are electrically isolated from the ground (e.g., by a space or air gap). In some cases, the minimum number of electrodes in the array is two (2): a transmitting electrode and a receiving electrode. However, in other applications, the array may consist of a two dimensional array of multiple electrodes, e.g., 5 or more electrodes.

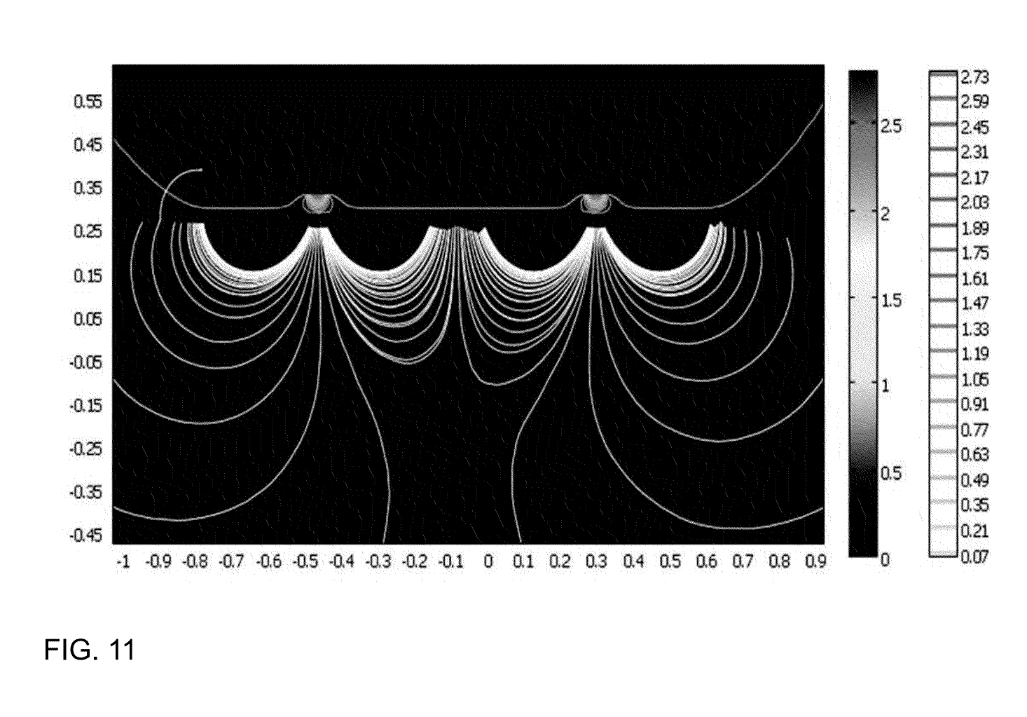

FIG. 11 shows a schematic depiction of a preliminary (test) sensor design. This design has a total of ten (10) electrodes, arranged in a linear array with uniform separation of D. Also shown are a ground surface and targets with two layers/volumes of interest. Two are transmitting electrodes (TX1 and TX2). The remaining eight are receiving electrodes (R1-R8). In this example arrangement, the characteristic of the electrodes (e.g., transmitting or receiving) is fixed. In this example arrangement, eight separate physical volumes may be sensed over a distance of nine times the separation distance, (D) as separate physical volumes. The electrodes can be electrically insulated from one another, and can be separated from the surface and subsurface (e.g., ground surface) by a gap.

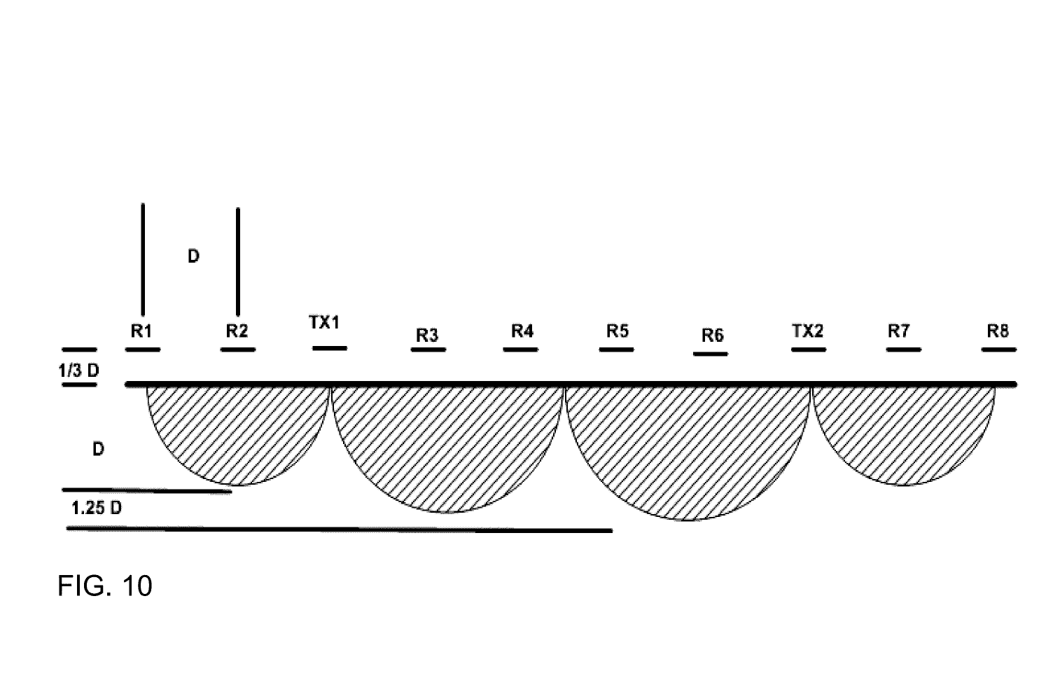

The electrodes may be arranged in any number of manners, and may be arranged in a planar array in some embodiments. In some cases, the planar array can include a linear array of electrodes as shown in the schematic depiction of FIG. 10, or in a series of linear arrays as discussed further herein.

In various embodiments, the electrodes can be spaced in such a manner as to obtain a desired amount of penetration into the ground. For example, generally, the electrodes may be spaced in such a manner that for penetration to a desired depth D, the electrodes are spaced apart a distance of 2D. That is, in various embodiments, each electrode is spaced apart from its adjacent electrode at twice the distance of the desired penetration into the ground. In the example arrangement of the electrodes in FIG. 10, the maximum depth between TX1 and TX2 is about 1.25 times D. This is illustrated in the finite element model using Comsol Multiphysics of the sensor array (FIG. 10) as shown in FIG. 11. In applications according to various embodiments of the invention, there will be an air gap between the sensor array and the surface (e.g., ground surface). The size of this gap may be as great as 15-cm (6-in). As air gaps exceed about 1-cm (0.5-in), the actual depth of penetration into the ground will be affected and the signal-to-noise ratio will decrease.

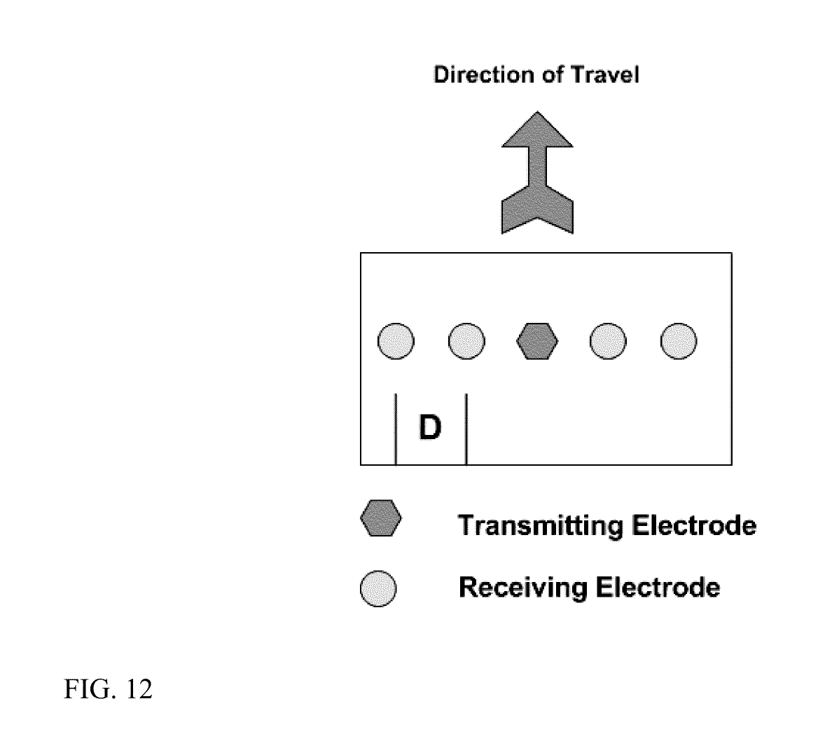

The schematic depiction of an array in FIG. 12 illustrates how the sensor array similar to that in FIG. 10 could be applied in a hand-held manual operation. If D=15-cm (6-in), the width of coverage could be on the order of approximately 60-cm (24-in) and therefore have a maximum depth of about D.

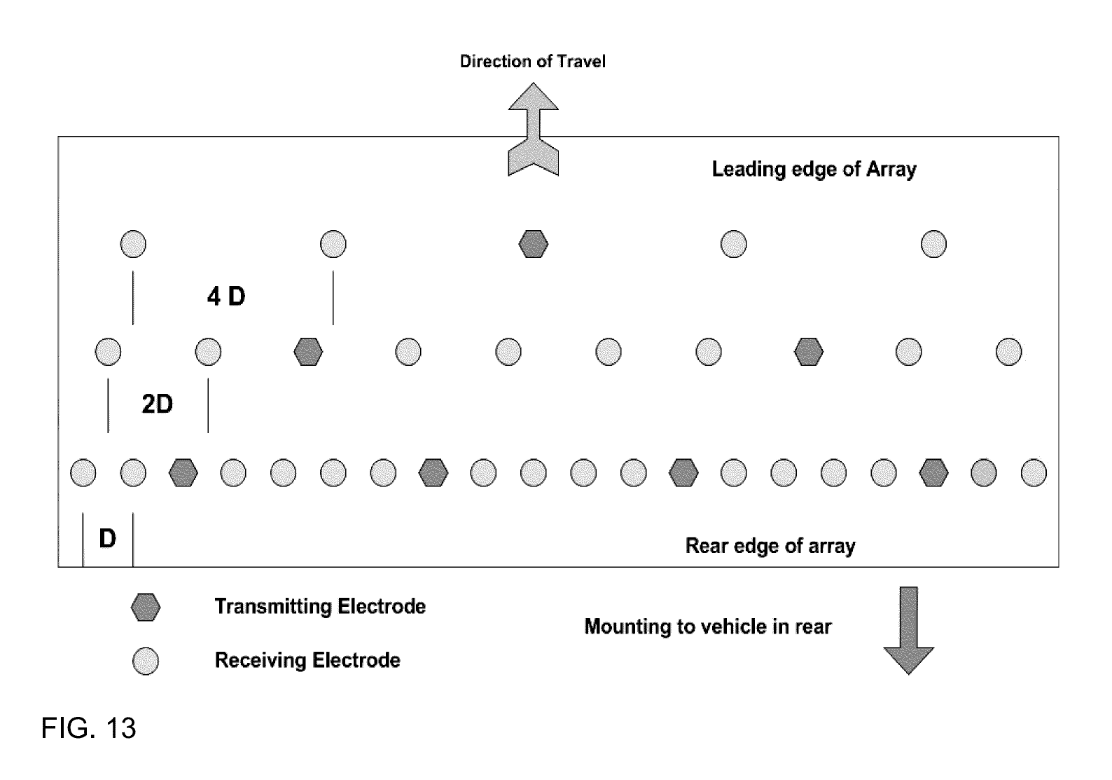

For vehicular applications, there are a number of additional criteria which may be considered in the design of the sensor array. One is that the desired maximum depth of anomaly detection in some cases is approximately 1 meter (˜40 in). For the sensor array shown in FIG. 13, if D=25 centimeters (˜10 inches), the maximum depth of detection would be approximately one meter (˜40 inches). In addition, it may be beneficial to be able to locate the depth of the potential targets. This can involve an array configuration that looks at depths typical for antipersonnel objects of interest (BEHs), and a distinct (or potentially the same) array designed to detect a BEH designed to destroy an armored vehicle. In addition, the width of the path to be covered can range from approximately 2.5 meters (˜8 feet) to approximately 3.7 meters (˜12 feet). It has been discovered by the inventors that the array shown in the schematic depiction of FIG. 13 can satisfy these requirements. If D=15 cm (6 in), the width is about 2.9-meters (˜8.8 feet) with a depth coverage from D to 4D (˜15 cm to ˜60 cm). If D=25-cm (10-in), the width is about 4.7-meters (15.7-feet) with a depth coverage from D to 4D (25 cm to 100 cm).

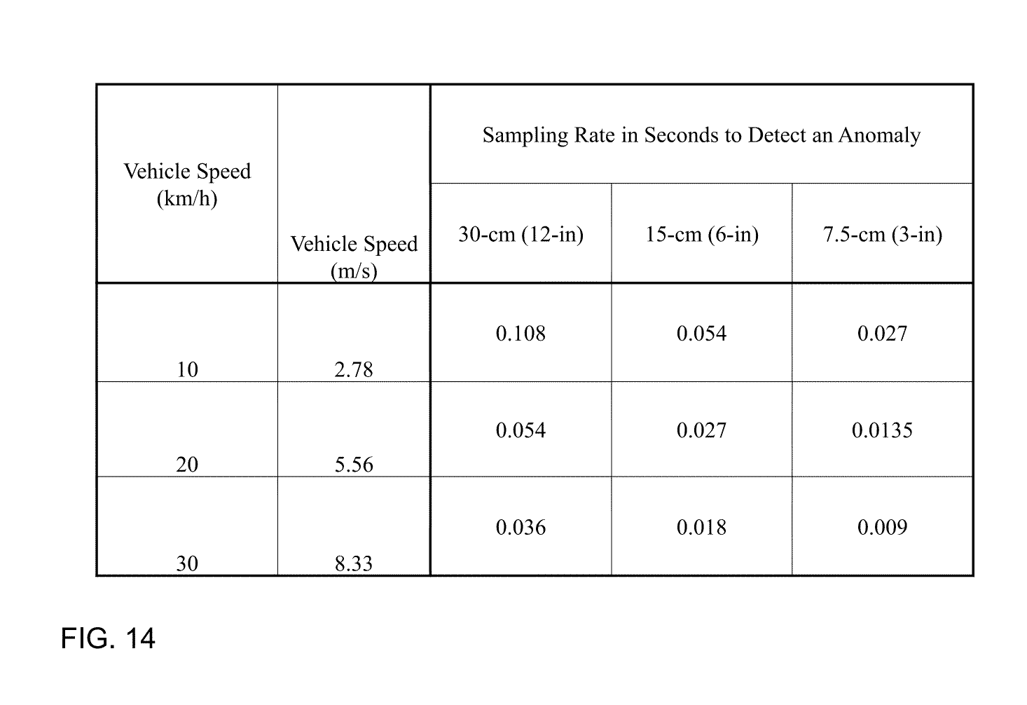

For vehicular applications, there can be other criteria that affect the design of the electronics (e.g., sensor spacing) and algorithms. For example, the speed at which the vehicle may travel and detect targets of various sizes can affect the design of the sensor array. As explained herein regarding the tomography approach, movement in the direction of travel is used as part of the tomographic location of the targets. The table in FIG. 14 provides the maximum amount of time allowed to detect a target of a given size, in some particular embodiments. These time frames can be based upon the distance that will be traveled to determine the length dimension of the object in the direction of travel. Determination of the size of the anomaly in width and depth dimensions can be determined in one scan of the sensor array (and related electronics), which can require approximately 0.01 to approximately 0.05 seconds.

Tomographic Methodology:

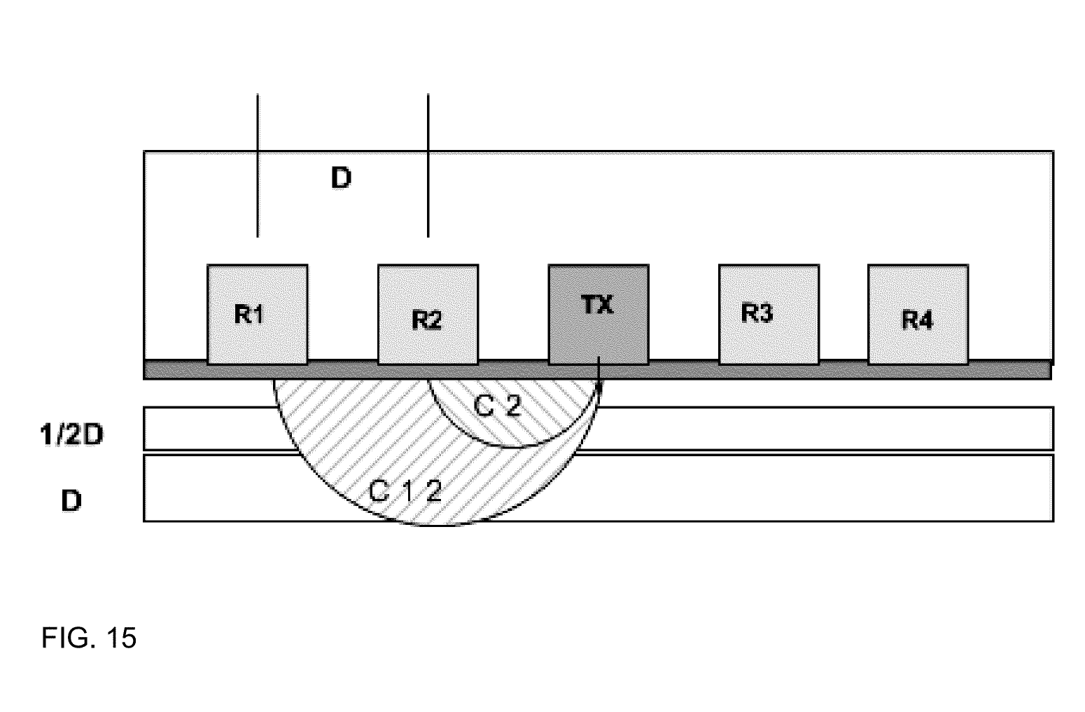

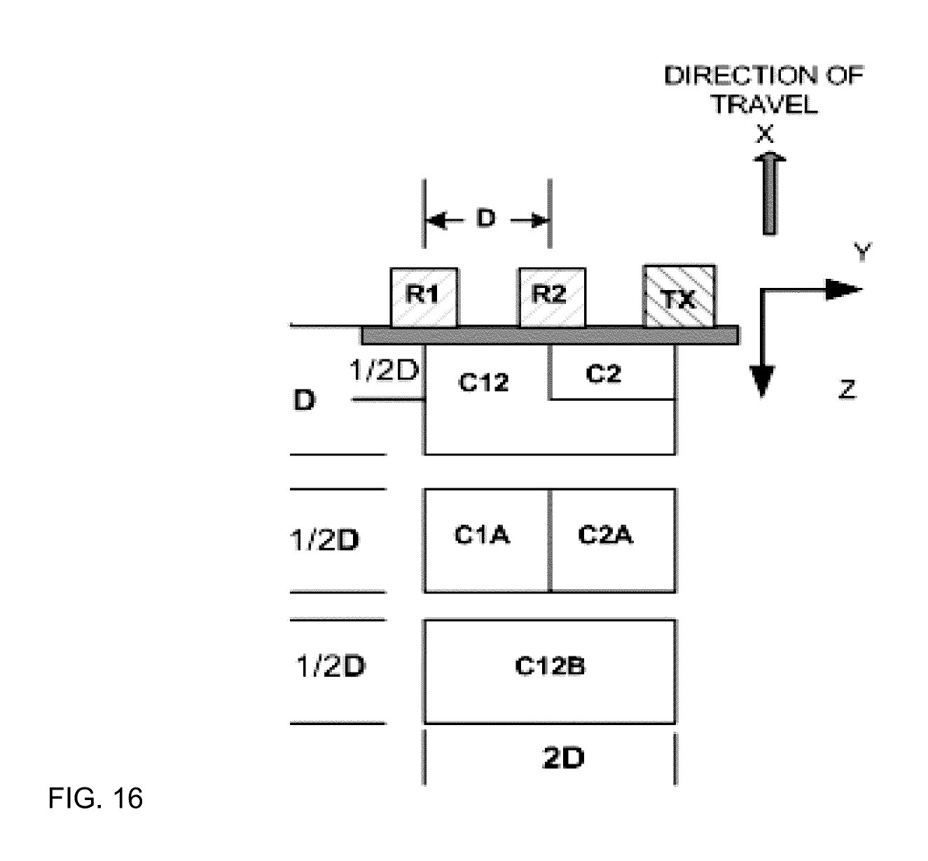

As noted above, there are many methods to develop tomographic representations from impedance data. Most of the approaches involve using impedance data from a multidimensional array to provide a 3-dimensional visualization of the target. These approaches are designed to provide fine resolution of the image being generated. If the need for resolution is relaxed, the method of providing a three dimensional location of a buried target can be simplified. This can be significant because a simplified approach requires less computational time to meet the time requirements noted in the sampling rate table of FIG. 14. For example, for the five electrode array shown in the schematic depiction of FIG. 15, the approximate shape of the “voxel” volume whose impedance characteristic is measured by the array is shown in the schematic depiction of FIG. 16.

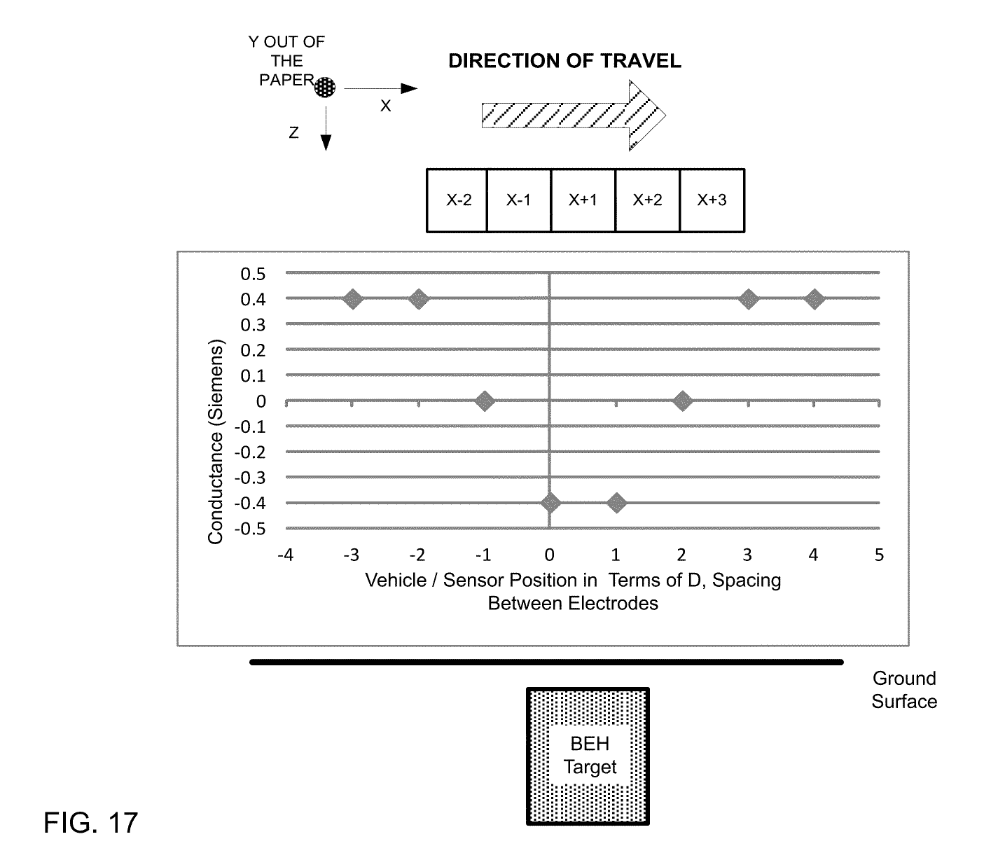

In the following discussion of FIG. 15 and FIG. 16, the term “voxel” refers to the volume of the MUT whose impedance characteristics are directly measured (e.g. C2 and C12 in FIG. 16) and the term “sub-voxel” is a portion of a larger voxel whose properties are determined by computation using the measure and computed sub-voxels (e.g. CIA, C2A, and C12B). If, in some examples, the location criterion is a cube with maximum dimensions of D by D by D, it is beneficial to only identify one “voxel” of interest, C2, as is illustrated in FIG. 16 and described as follows. With reference to FIG. 16, the voxel C2 is determined to be D in the Y (width), and ½ D in the Z (depth) direction based upon the geometry of the sensor array, and the speed of travel and data collection in the X (length) value determined by the user in the direction of travel, (further described with reference to FIG. 17). How fast and how far the user moves the array in the direction of travel, determines the “voxel” dimension in that direction. The variation in the complex impedance in the “voxel” determines the location of the target. This illustrative discussion according to embodiments herein is for one half of the five electrode array schematically shown in FIG. 15. The transmitting electrode and two receiving electrodes, R1 and R2 are shown in FIG. 16, representing the “voxel” of FIG. 15 as a rectilinear “voxel” in FIG. 16. The electronics measure the impedance characteristics of “voxel” C2 and “voxel” C12.

The desired discrimination is for “voxels” C1A and C2A and “sub-voxel” C12B in FIG. 16. In the field, another measurement could be made to measure the impedance characteristics of a “voxel” C1. For illustrative purposes only, it may be assumed that for a good approximation, the measured electrical impedance of “voxel” C1 is the same as for “voxel” C2 and equal to CIA and C2A. Under this assumption, series combination of “voxels” C1A and C2A may be combined in a parallel combination with the measured impedance characteristics of C12 to determine the impedance characteristics of “sub-voxel” C12B.

The discussion above assumes that the spacing is equal in each direction. By constraining the planar linear array to equally spaced electrodes, thereby deliberately limiting the degrees of freedom, the equations can stand. However, this can limit the design and application of the sensor, and ignores the fact that that the measured volumes are not simple rectilinear volumes. This condition may be relaxed by the inclusion of a geometric correction factor.

This approach may be used for the tomographic detection phase and for the spectrographic characterization phase. The range of frequencies and the number of frequencies used in each function may be different since they will be selected to optimize the function and minimize the time required for each function.

FIG. 17 illustrates a schematic graphical depiction of the position of a vehicle relative to a ground surface (overlying an object of interest such as a BEH target), plotted in conjunction with conductance. This graphical depiction illustrates how the movement of the vehicle and the sensor array will provide the third dimension for the voxel. As the array is moved (e.g., with the vehicle), readings from the array will be taken at various distances, typically equal to the spacing of the electrodes. The illustrative data that may be seen are also shown similar to that observed in FIGS. 7 and 8.

The readings shown in FIG. 17 can help to define the dimension of the anomaly in the x-direction of travel. The spacing of the sensors in y-direction of the array can provide the observations in the y-direction, as well as other depths in the z-direction as illustrated in FIG. 16. The three-dimensional set of voxels will then be available to determine the approximate size, location and characteristics of the anomaly.

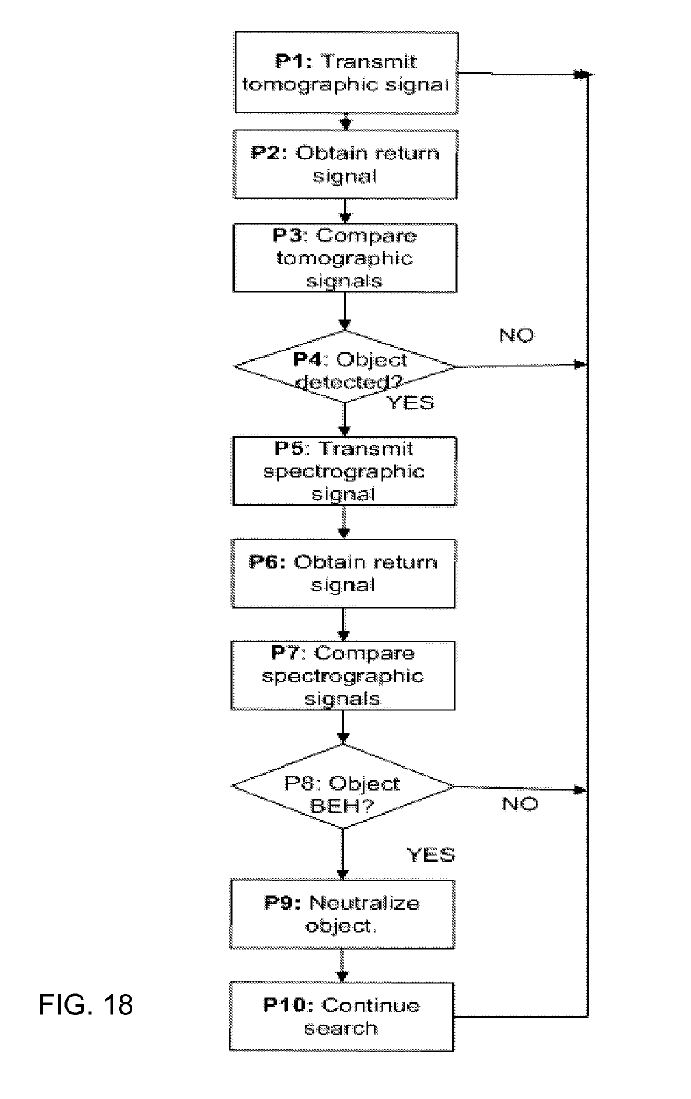

As described herein, various aspects of the invention can include computer implemented methods, systems and computer program products for performing a series of functions. In some cases, a system is described which includes an array of electrodes for non-conductively communicating with a surface and a subsurface beneath the surface. As described herein, the array of electrodes can be configured in a plurality of distinct ways to detect, and potentially determine the characteristics of, an object of interest. The system can further include a signal generator operably connected (e.g., hard-wired) with the array of electrodes. The system can further include at least one computing device operably connected with the signal generator (e.g., wirelessly and/or hard-wired) and the array of electrodes (e.g., wirelessly and/or hardwired, or simply via common connection with the signal generator). Referring to FIG. 18, the at least one computing device is configured to perform the following processes (not necessarily in this order):

P1: instruct the signal generator to transmit a first set of tomographic signals from the array of electrodes;

P2: obtain a first return signal from the array of electrodes about the surface and the subsurface beneath the surface;

P3: compare the first return signal with the first set of tomographic signals to determine whether an object is present within the subsurface;

P4: determine the presence of an anomaly. If NO, revert to P1. If YES, continue to P5.

P5: instruct the signal generator to transmit a set of spectrographic signals from the array of electrodes in response to determining the object is present within the subsurface;

P6: obtain a second return signal from the array of electrodes about the surface and the subsurface beneath the surface; and

P7: compare the second return signal with the set of spectrographic signals to determine a characteristic of the object within the subsurface.

P8: determine if the anomaly is an object of interest (e.g., a BEH). If NO, revert to P1. If YES, continue to P9.

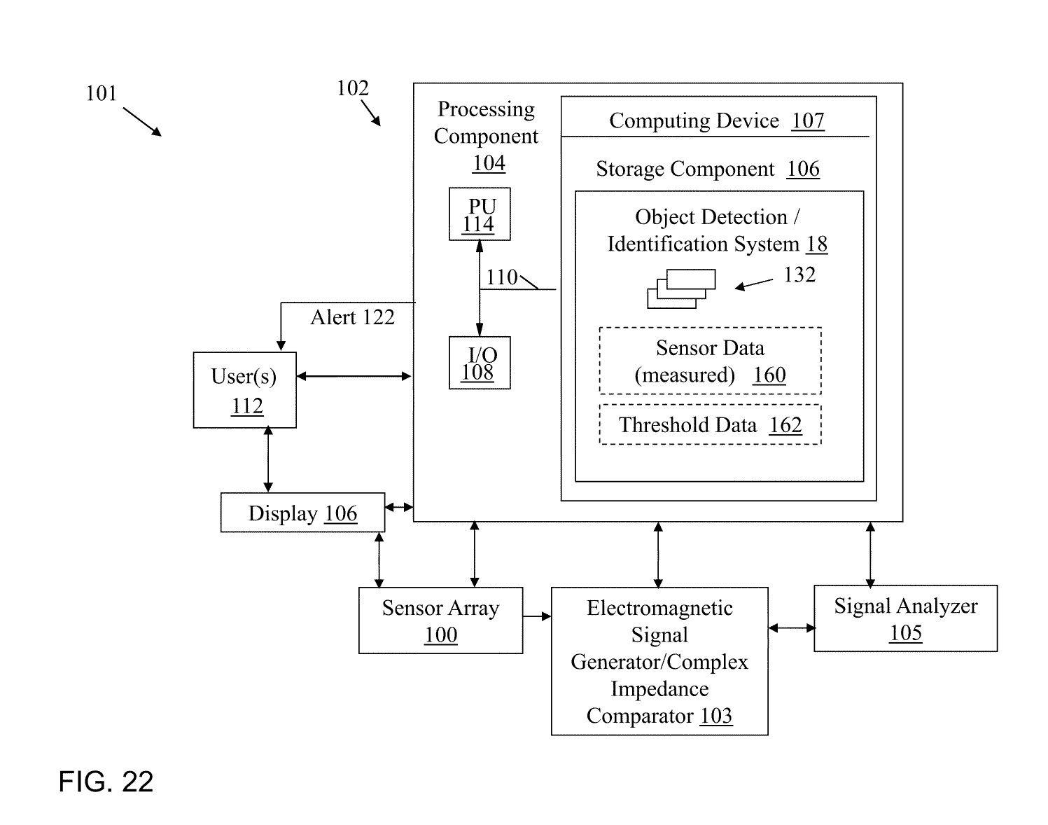

P9: Issue a warning (e.g., an alert 122, FIG. 22) to neutralize the BEH.

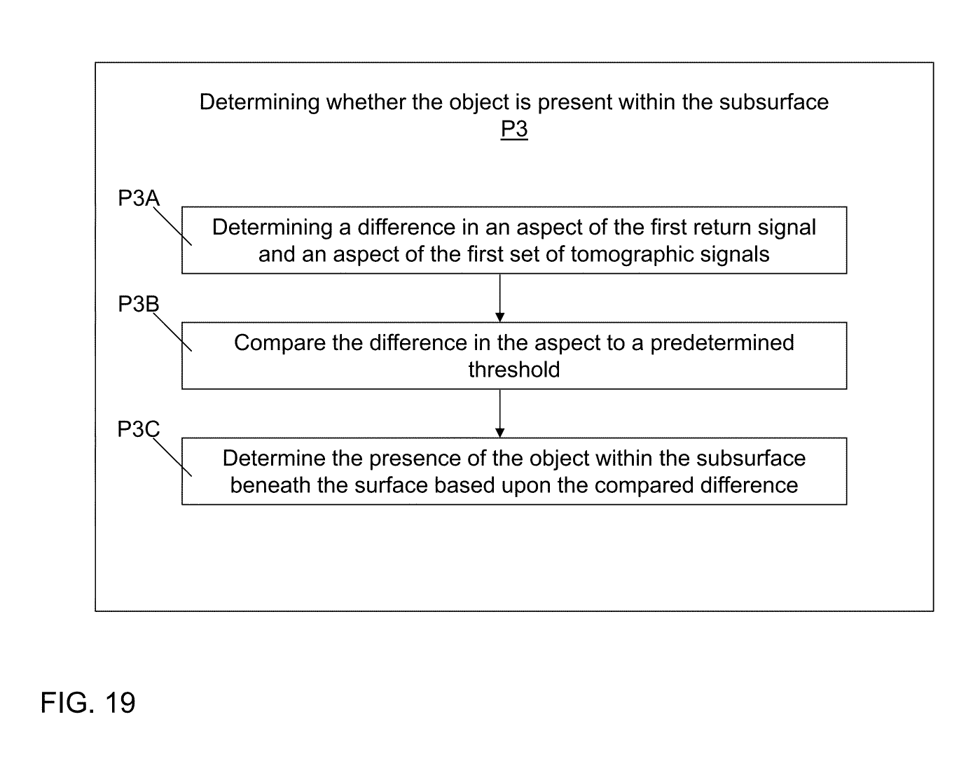

In some cases, as illustrated in FIG. 19, process P3 (determining of whether the object is present within the subsurface) includes the following sub-processes:

P3A: determining a difference in an aspect of the first return signal and an aspect of the first set of tomographic signals;

P3B: compare the difference in the aspect to a predetermined threshold; and

P3C: determine the presence of the object within the subsurface beneath the surface based upon the compared difference.

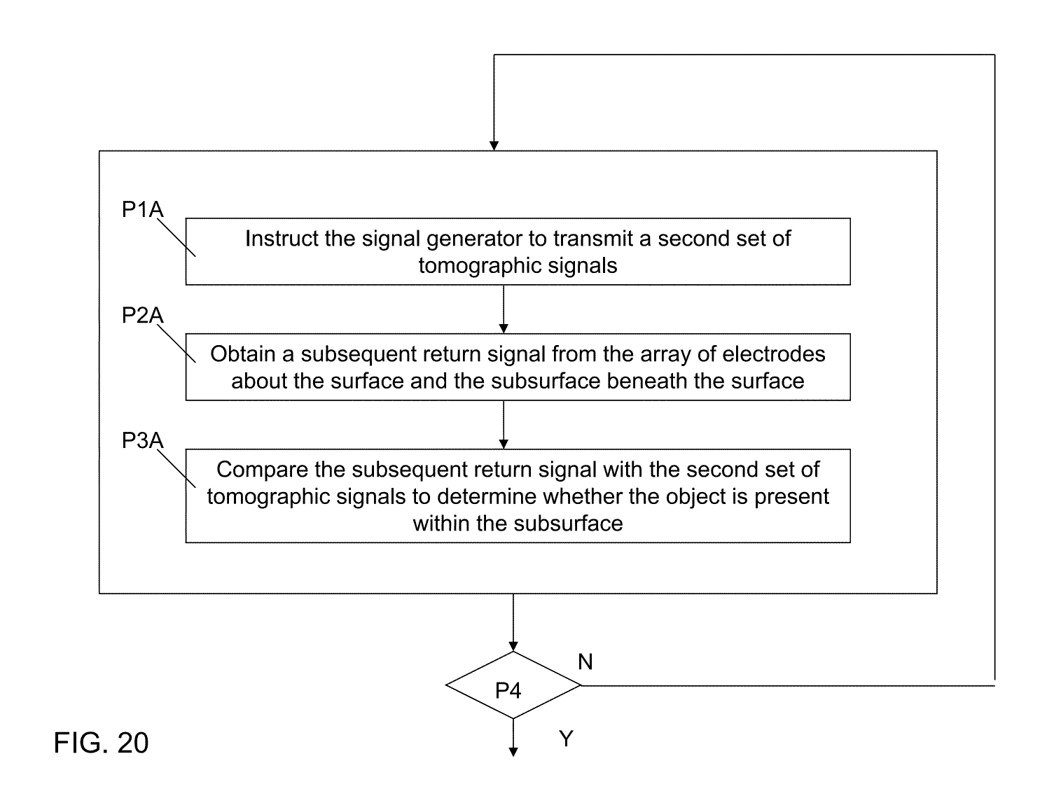

In some cases, as shown in FIG. 20, in response to determining that the object is not present within the subsurface (NO to decision P4), the at least one computing device (e.g., computing device 107, FIG. 22) is configured to return to process P1, iteratively perform the following:

P1A: instruct the signal generator to transmit a second set of tomographic signals;

P2A: obtain a subsequent return signal from the array of electrodes about the surface and the subsurface beneath the surface; and

P3A: compare the subsequent return signal with the second set of tomographic signals to determine whether the object is present within the subsurface.

It is understood that processes P1A-P3A represent an iterative adjustment of the tomographic signals in order to aid in determining whether an object is present in the subsurface.

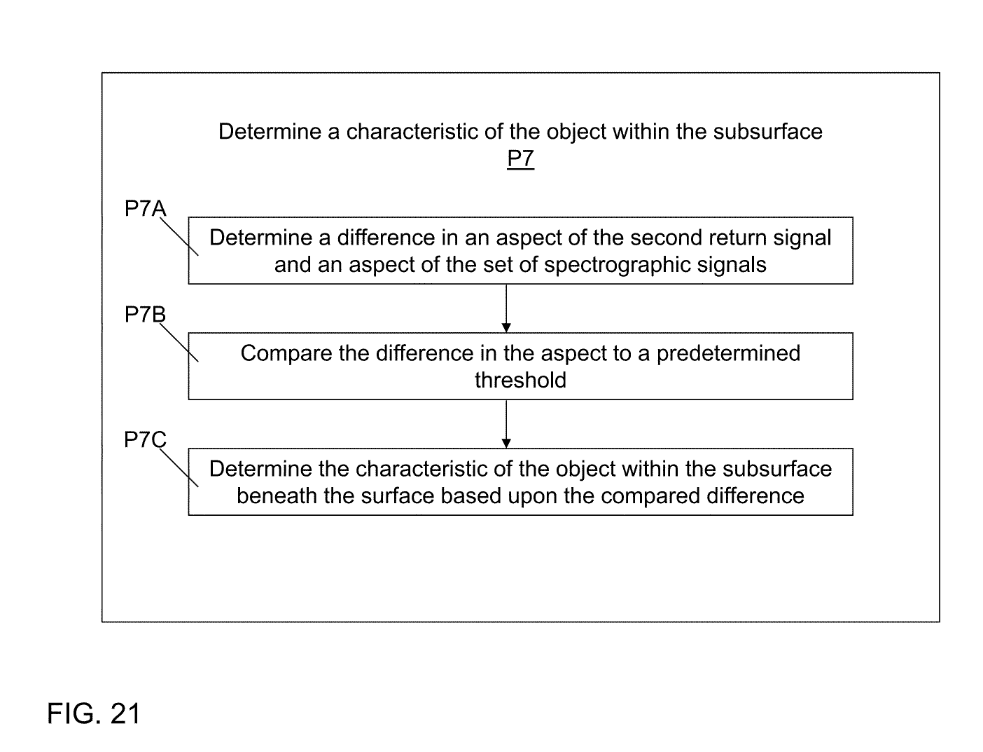

In some cases, as shown in FIG. 21, the determining of the characteristic of the object (P7) within the subsurface includes:

P7A: determining a difference in an aspect of the second return signal and an aspect of the set of spectrographic signals;

P7B: compare the difference in the aspect to a predetermined threshold; and

P7C: determine the characteristic of the object within the subsurface beneath the surface based upon the compared difference.

In some embodiments, the characteristic of the object includes at least one of a size of the object, a shape of the object or a density of the object. In various embodiments, the tomographic signals include oscillating electromagnetic field signals transmitted over a first range of frequencies. In some embodiments, the spectrographic signals include oscillating electromagnetic field signals transmitted over a second range of frequencies distinct from the first range of frequencies. In various embodiments, the surface includes a ground surface. In some embodiments, the subsurface includes at least one of soil, vegetation, asphalt, asphalt emulsion or sand.

FIG. 22 depicts an illustrative environment 101 for performing the object detection/identification (e.g., BEH detection) processes described herein with respect to various embodiments. To this extent, the environment 101 includes a computer system 102 that can perform one or more processes described herein in order to control operation of a sensor array system (e.g., sensor array 100, FIG. 3), an electromagnetic signal generator/complex impedance comparator (e.g., electromagnetic signal generator/complex impedance comparator 103, FIG. 3), a signal analyzer (e.g., signal analyzer 104, FIG. 3), a vehicle controller (e.g., a vehicle controller 105) and/or a display (e.g., display 106, FIG. 3). In particular, the computer system 102 is shown as including an object detection/identification system 18, which makes computer system 102 operable to detect and/or identify an object within a subsurface by performing any/all of the processes described herein and implementing any/all of the embodiments described herein.

The computer system 102 is shown including a computing device 107, which can include a processing component 104 (e.g., one or more processors), a storage component 106 (e.g., a storage hierarchy), an input/output (I/O) component 108 (e.g., one or more I/O interfaces and/or devices), and a communications pathway 110. In general, the processing component 104 executes program code, such as the object detection/identification system 18, which is at least partially fixed in the storage component 106. While executing program code, the processing component 104 can process data, which can result in reading and/or writing transformed data from/to the storage component 106 and/or the I/O component 108 for further processing. The pathway 110 provides a communications link between each of the components in the computer system 102. The I/O component 108 can comprise one or more human I/O devices, which enable a user (e.g., a human and/or computerized user) 112 to interact with the computer system 102 and/or one or more communications devices to enable the system user 112 to communicate with the computer system 102 using any type of communications link. To this extent, the object detection/identification system 18 can manage a set of interfaces (e.g., graphical user interface(s), application program interface, etc.) that enable human and/or system users 112 to interact with the control system 18. Further, the object detection/identification system 18 can manage (e.g., store, retrieve, create, manipulate, organize, present, etc.) data, such as sensor data 160 and/or threshold data 162 using any solution. It is understood that the sensor data 160 can include data obtained by the sensor array 100 about the presence of an object within or below a surface/subsurface 101. Threshold data 162 can include data representing one or more thresholds used to determine whether an object is present within the surface and/or subsurface, and/or a characteristic of the object, if present. That is, the threshold data 162 can be based upon predetermined conditions which account for a threshold level of tomographic and/or spectrographic differential between the output signals and the return signals. The object detection/identification system 18 can additionally communicate with the sensor array 100, signal generator/complex impedance comparator 103, microprocessor controller and signal analyzer 104, vehicle controller 105, user 112 and/or display 106, e.g., via wireless and/or hardwired means.

In any event, the computer system 102 can comprise one or more general purpose computing articles of manufacture (e.g., computing devices) capable of executing program code, such as the object detection/identification system 18, installed thereon. As used herein, it is understood that “program code” means any collection of instructions, in any language, code or notation, that cause a computing device having an information processing capability to perform a particular function either directly or after any combination of the following: (a) conversion to another language, code or notation; (b) reproduction in a different material form; and/or (c) decompression. To this extent, the object detection/identification system 18 can be embodied as any combination of system software and/or application software. It is further understood that the object detection/identification system 18 can be implemented in a cloud-based computing environment, where one or more processes are performed at distinct computing devices (e.g., a plurality of computing devices 103), where one or more of those distinct computing devices may contain only some of the components shown and described with respect to the computing device 107 of FIG. 22.

Further, the object detection/identification system 18 can be implemented using a set of modules 132. In this case, a module 132 can enable the computer system 102 to perform a set of tasks used by the object detection/identification system 18, and can be separately developed and/or implemented apart from other portions of the object detection/identification system 18. As used herein, the term “component” means any configuration of hardware, with or without software, which implements the functionality described in conjunction therewith using any solution, while the term “module” means program code that enables the computer system 102 to implement the functionality described in conjunction therewith using any solution. When fixed in a storage component 106 of a computer system 102 that includes a processing component 104, a module is a substantial portion of a component that implements the functionality. Regardless, it is understood that two or more components, modules, and/or systems may share some/all of their respective hardware and/or software. Further, it is understood that some of the functionality discussed herein may not be implemented or additional functionality may be included as part of the computer system 102.

When the computer system 102 comprises multiple computing devices, each computing device may have only a portion of object detection/identification system 18 fixed thereon (e.g., one or more modules 132). However, it is understood that the computer system 102 and object detection/identification system 18 are only representative of various possible equivalent computer systems that may perform a process described herein. To this extent, in other embodiments, the functionality provided by the computer system 102 and object detection/identification system 18 can be at least partially implemented by one or more computing devices that include any combination of general and/or specific purpose hardware with or without program code. In each embodiment, the hardware and program code, if included, can be created using standard engineering and programming techniques, respectively.

Regardless, when the computer system 102 includes multiple computing devices, the computing devices can communicate over any type of communications link. Further, while performing a process described herein, the computer system 102 can communicate with one or more other computer systems using any type of communications link. In either case, the communications link can comprise any combination of various types of wired and/or wireless links; comprise any combination of one or more types of networks; and/or utilize any combination of various types of transmission techniques and protocols.

The computer system 102 can obtain or provide data, such as sensor data 160 and/or threshold data 162 using any solution. The computer system 102 can generate sensor data 160 and/or threshold data 162, from one or more data stores, receive sensor data 160 and/or threshold data 162, from another system such as the sensor array 100, signal generator/complex impedance comparator 103, microprocessor controller and signal analyzer 104, vehicle controller 105, user 112 and/or display 106, send sensor data 160 and/or threshold optical data 162 to another system, etc.

While shown and described herein as a method and system for detecting and identifying an object within a surface/subsurface, it is understood that aspects of the invention further provide various alternative embodiments. For example, in one embodiment, the invention provides a computer program fixed in at least one computer-readable medium, which when executed, enables a computer system to detect and identify an object within a surface/subsurface. To this extent, the computer-readable medium includes program code, such as the object detection/identification system 18 (FIG. 22), which implements some or all of the processes and/or embodiments described herein. It is understood that the term “computer-readable medium” comprises one or more of any type of tangible medium of expression, now known or later developed, from which a copy of the program code can be perceived, reproduced, or otherwise communicated by a computing device. For example, the computer-readable medium can comprise: one or more portable storage articles of manufacture; one or more memory/storage components of a computing device; paper; etc.

In another embodiment, the invention provides a method of providing a copy of program code, such as the object detection/identification system 18 (FIG. 22), which implements some or all of a process described herein. In this case, a computer system can process a copy of program code that implements some or all of a process described herein to generate and transmit, for reception at a second, distinct location, a set of data signals that has one or more of its characteristics set and/or changed in such a manner as to encode a copy of the program code in the set of data signals. Similarly, an embodiment of the invention provides a method of acquiring a copy of program code that implements some or all of a process described herein, which includes a computer system receiving the set of data signals described herein, and translating the set of data signals into a copy of the computer program fixed in at least one computer-readable medium. In either case, the set of data signals can be transmitted/received using any type of communications link.

In still another embodiment, the invention provides a method of generating a system for detecting/identifying an object within a surface/subsurface. In this case, a computer system, such as the computer system 102 (FIG. 22), can be obtained (e.g., created, maintained, made available, etc.) and one or more components for performing a process described herein can be obtained (e.g., created, purchased, used, modified, etc.) and deployed to the computer system. To this extent, the deployment can comprise one or more of: (1) installing program code on a computing device; (2) adding one or more computing and/or I/O devices to the computer system; (3) incorporating and/or modifying the computer system to enable it to perform a process described herein; etc.

In any case, the technical effect of the invention, including, e.g., the object detection/identification system 18, is to control operation of a sensor array 100, signal generator/complex impedance comparator 103, microprocessor controller and signal analyzer 104, vehicle controller 105, user 112 and/or display 106 to detect/identify an object within a surface/subsurface in one of the various manners described and illustrated herein.

### Example Application According to Various Embodiments

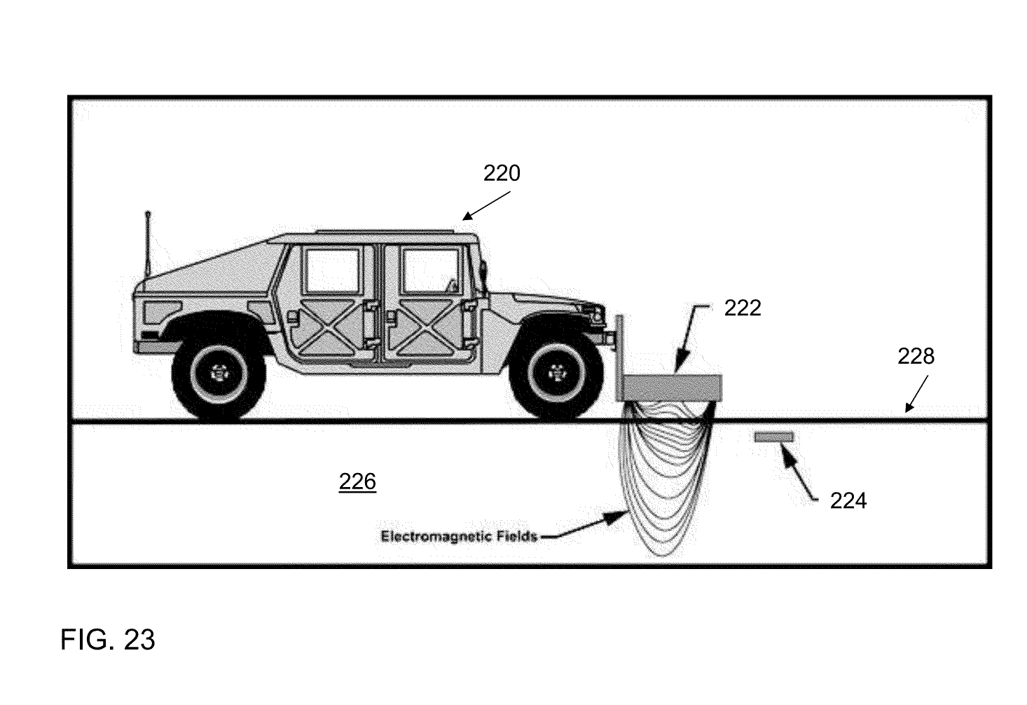

Turning to FIG. 23, an example application of various aspects of the invention is illustrated in the schematic side view of a vehicle 220 coupled with a sensor array 222 for detecting an object 224 (e.g., a BEH target) within a subsurface 226 beneath a surface 228. The sensor array 222 can include components similar to the array shown and described with reference to the array of FIG. 12. The array 222 can be mounted (e.g., physically bolted, fastened, etc.) on the vehicle 220 (e.g., a mine-resistant vehicle). As the vehicle 220 moves forward, the array 222 can be programmed in such a way that the deepest targets, which could be the largest and most dangerous targets, are detected first. The array 222 can be designed so that sequentially shallower targets which would be expected to be small and less dangerous to the vehicle 222.

Referring back to FIG. 13, the sensor array can be designed such that the electrode spacing is the greatest for the electrodes closest to the front of the array (direction of travel). These electrodes will detect the deepest objects in the surface/subsurface, which can be assumed to be the largest (and potentially most dangerous). These electrodes can also aid in detection of smaller (and shallower) objects, but may not provide the level of detail about those objects as those sets of closer-spaced electrodes nearer to the rear of the array, e.g., as to the size of an object or its depth within the surface or subsurface. The electrodes closer to the rear of the array can detect objects with greater discrimination, those objects which are smaller than those detected by the frontward area electrodes, and objects which are less deep in the surface/subsurface.

Returning to FIG. 23, as the vehicle 220 moves forward, the array 222 operates as a detector in the tomographic mode. Once a potential target (object 224) is detected, the vehicle 220 stops and changes the mode of the array 222 to the spectrographic mode to characterize the object 224, as described herein.

Various additional embodiments include a computer-implemented method including: (i) initiating a tomography analysis of a surface and a subsurface beneath the surface to detect an object within the subsurface; and (ii) initiating a spectrographic analysis of the subsurface in response to detecting the object within the subsurface, the spectrographic analysis for determining a characteristic of the buried object. In some cases, the spectrographic analysis includes: determining whether the characteristic of the object matches a predetermined characteristic for a buried explosive hazard (BEH); and providing an indicator that the buried object includes a BEH in response to determining the characteristic of the buried object matches the predetermined characteristic for the BEH.

Various other embodiments include a system including: an array of electrodes for non-conductively communicating with a surface and a subsurface beneath the surface; a signal generator operably connected with the array of electrodes; and at least one computing device operably connected with the signal generator and the array of electrodes, the at least one computing device configured to perform sequential tomographic and spectrographic surveys of the surface and the subsurface. In some cases, the at least one computing device is further configured to: instruct the signal generator to transmit a first set of tomographic signals from the array of electrodes; obtain a first return signal from the array of electrodes about the surface and the subsurface beneath the surface; compare the first return signal with the first set of tomographic signals to determine whether an object is present within the subsurface; instruct the signal generator to transmit a set of spectrographic signals from the array of electrodes in response to determining the object is present within the subsurface; obtain a second return signal from the array of electrodes about the surface and the subsurface beneath the surface; and compare the second return signal with the set of spectrographic signals to determine a characteristic of the object within the subsurface. Further, in some cases, in response to determining the object is not present within the subsurface, the at least one computing device is further configured to iteratively perform the following: providing instructions to the signal generator to transmit a second set of tomographic signals to the surface and the subsurface;

obtaining a subsequent return signal about the surface and the subsurface beneath the surface; and comparing the subsequent return signal with the second set of tomographic signals to determine whether the object is present within the subsurface. The process of determining whether the object is present within the subsurface can be performed by the at least one computing device by: determining a difference in an aspect of the first return signal and an aspect of the first set of tomographic signals; comparing the difference in the aspect to a predetermined threshold; and determining the presence of the object within the subsurface beneath the surface based upon the compared difference. In some cases, determining the characteristic of the object within the subsurface (e.g., by the at least one computing device) includes: determining a difference in an aspect of the second return signal and an aspect of the set of spectrographic signals; comparing the difference in the aspect to a predetermined threshold; and determining the characteristic of the object within the subsurface beneath the surface based upon the compared difference.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. It is further understood that the terms “front” and “back” are not intended to be limiting and are intended to be interchangeable where appropriate.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

We claim:

1. A system comprising:
an array of electrodes for non-conductively communicating with a surface and a subsurface beneath the surface;
a signal generator operably connected with the array of electrodes; and
at least one computing device operably connected with the signal generator and the array of electrodes, the at least one computing device configured to:
instruct the signal generator to transmit a first set of tomographic signals from the array of electrodes into the surface and the subsurface;
obtain a first return signal from the array of electrodes;
compare the first return signal with the first set of tomographic signals to determine whether an object is present within the subsurface;
instruct the signal generator to transmit a set of spectrographic signals from the array of electrodes in response to determining the object is present within the subsurface; obtain a second return signal from the array of electrodes; and
compare the second return signal with the set of spectrographic signals to determine a characteristic of the object.

2. The system of claim 1, wherein, in response to determining the object is not present within the subsurface, the at least one computing device is further configured to iteratively perform the following:
instruct the signal generator to transmit a second set of tomographic signals;
obtain a subsequent return signal from the array of electrodes; and
compare the subsequent return signal with the second set of tomographic signals to determine whether the object is present within the subsurface.

3. The system of claim 1, wherein the determining of whether the object is present within the subsurface by the at least on computing device includes:
determining a difference in an aspect of the first return signal and an aspect of the first set of tomographic signals;
comparing the difference in the aspect to a predetermined threshold; and
determining the presence of the object within the subsurface beneath the surface based upon the compared difference.

4. The system of claim 1, wherein the determining of the characteristic of the object within the subsurface by the at least one computing device includes:
determining a difference in an aspect of the second return signal and an aspect of the set of spectrographic signals;
comparing the difference in the aspect to a predetermined threshold; and
determining the characteristic of the object within the subsurface beneath the surface based upon the compared difference.

5. The system of claim 1, wherein the characteristic of the object includes at least one of a location of the object, a size of the object, a shape of the object, a density of the object, or whether the object includes a buried explosive hazard.

6. The system of claim 1, wherein the tomographic signals include oscillating electromagnetic field signals transmitted over a first range of frequencies.

7. The system of claim 6, wherein the spectrographic signals include oscillating electromagnetic field signals transmitted over a second range of frequencies distinct from the first range of frequencies.

8. A computer-implemented method comprising:
providing instructions to a signal generator to transmit a first set of tomographic signals to a surface and a subsurface beneath the surface;
obtaining a first return signal associated with the first set of tomographic signals;
comparing the first return signal with the first set of tomographic signals to determine whether an object is present within the subsurface;
providing instructions to the signal generator to transmit a set of spectrographic signals to the surface and the subsurface in response to determining the object is present within the subsurface;
obtaining a second return signal associated with the set of spectrographic signals; and comparing the second return signal with the set of spectrographic signals to determine a characteristic of the object within the subsurface.

9. The computer-implemented method of claim 8, wherein, in response to determining the object is not present within the subsurface, the method further includes iteratively performing the following:
providing instructions to the signal generator to transmit a second set of tomographic signals to the surface and the subsurface;
obtaining a subsequent return signal associated with the second set of tomographic signals; and
comparing the subsequent return signal with the second set of tomographic signals to determine whether the object is present within the subsurface.

10. The method of claim 8, wherein the determining of whether the object is present within the subsurface includes:
determining a difference in an aspect of the first return signal and an aspect of the first set of tomographic signals;
comparing the difference in the aspect to a predetermined threshold; and
determining the presence of the object within the subsurface beneath the surface based upon the compared difference.

11. The method of claim 8, wherein the determining of the characteristic of the object within the subsurface includes:
determining a difference in an aspect of the second return signal and an aspect of the set of spectrographic signals;
comparing the difference in the aspect to a predetermined threshold; and
determining the characteristic of the object within the subsurface beneath the surface based upon the compared difference.

12. The method of claim 8, wherein the characteristic of the object includes at least one of a location of the object, a size of the object, a shape of the object, a density of the object, or whether the object includes a buried explosive hazard.

13. The method of claim 8, wherein the tomographic signals include oscillating electromagnetic field signals transmitted over a first range of frequencies.

14. The method of claim 13, wherein the spectrographic signals include oscillating electromagnetic field signals transmitted over a second range of frequencies distinct from the first range of frequencies.

15. A computer program comprising program code stored on a computer-readable medium, which when executed by at least one computing device, causes the at least one computing device to:
provide instructions to a signal generator to transmit a first set of tomographic signals to a surface and a subsurface beneath the surface;
obtain a first return signal about the surface and the subsurface beneath the surface, the first return signal associated with the first set of tomographic signals;
compare the first return signal with the first set of tomographic signals to determine whether an object is present within the subsurface;
provide instructions to the signal generator to transmit a set of spectrographic signals to the surface and the subsurface in response to determining the object is present within the subsurface;
obtain a second return signal about the surface and the subsurface beneath the surface, the second return signal associated with the set of spectrographic signals; and
compare the second return signal with the set of spectrographic signals to determine a characteristic of the object within the subsurface.

16. The computer program of claim 15, wherein, in response to determining the object is not present within the subsurface, the at least one computing device performs the following:
provides instructions to the signal generator to transmit a second set of tomographic signals to the surface and the subsurface;
obtains a subsequent return signal about the surface and the subsurface beneath the surface; and
compares the subsequent return signal with the second set of tomographic signals to determine whether the object is present within the subsurface.

17. The computer program of claim 15, wherein the determining of whether the object is present within the subsurface includes:
determining a difference in an aspect of the first return signal and an aspect of the first set of tomographic signals;
comparing the difference in the aspect to a predetermined threshold; and
determining the presence of the object within the subsurface beneath the surface based upon the compared difference.

18. The computer program of claim 15, wherein the determining of the characteristic of the object within the subsurface includes:
determining a difference in an aspect of the second return signal and an aspect of the set of spectrographic signals;
comparing the difference in the aspect to a predetermined threshold; and
determining the characteristic of the object within the subsurface beneath the surface based upon the compared difference.

19. The computer program of claim 15, wherein the characteristic of the object includes at least one of a location of the object, a size of the object, a shape of the object, a density of the object or whether the object includes a buried explosive hazard.

20. The computer program of claim 19, wherein the tomographic signals include oscillating electromagnetic field signals transmitted over a first range of frequencies, and
wherein the spectrographic signals include oscillating electromagnetic field signals transmitted over a second range of frequencies distinct from the first range of frequencies.
